(19) United States
(12) Patent Application Publication
(10) Pub. No.: US 2026/0205569 A1
(43) Pub. Date: Jul. 16, 2026

(54) FLOATING STEREOSCOPIC DISPLAY DEVICE

(71) Applicant: AUO Display Plus Corporation, Hsinchu City (TW)

(72) Inventors: Ming-Tien LIN, Hsinchu City (TW); Shih-Yao HUNG, Hsinchu City (TW); Kuan-Ting CHEN, Hsinchu City (TW)

(21) Appl. No.: 19/571,584

(22) Filed: Mar. 19, 2026

(30) Foreign Application Priority Data
Oct. 13, 2025 (TW) 114139272

(51) Int. Cl. H04N 13/351

(52) U.S. Cl. CPC H04N 13/351

(57) ABSTRACT

A floating stereoscopic display device includes a plurality of floating display modules disposed adjacent to each other. Each of the plurality of floating display modules includes an image processor, and the image processor of each of the plurality of floating display modules provides respective stereoscopic image data. The stereoscopic image data provided by each of the image processors is generated in response to different simulated viewing angle ranges of reference image data. Each of the plurality of floating display modules projects a stereoscopic image in a corresponding one of a plurality of stereoscopic display spaces according to the respective stereoscopic image data. The plurality of stereoscopic display spaces are at least partially overlapped to form a stereoscopic imaging space, and the stereoscopic images projected by the plurality of floating display modules in the stereoscopic imaging space are combined to form a floating stereoscopic image.

### CROSS-REFERENCE TO RELATED APPLICATION

This application claims the priority benefit of Taiwan application serial no. 114139272 filed on October 13, 2025. The entirety of the above-mentioned patent applications is hereby incorporated by reference herein and made a part of this specification.

### BACKGROUND

### Technical Field

The present invention relates to a floating stereoscopic display device. Specifically, the present invention relates to a floating stereoscopic display device including a plurality of floating display modules.

### Related Art

Virtual Reality (VR) and Augmented Reality (AR) displays are capable of providing users with highly realistic floating stereoscopic interactive experiences; however, such experiences generally require the use of dedicated wearable devices. Although conventional naked-eye stereoscopic display technologies are already well developed, they rely on binocular vision at a fixed focal distance, in which stereoscopic perception is formed by the brain through left/right eye parallax. This often leads to vergence–accommodation conflict, resulting in visual fatigue and making such technologies unsuitable for long-term use. Light field displays are currently the type of stereoscopic display technology that most closely matches the natural human visual system. With advancements in technology, high-precision and high-resolution panel displays have become capable of mass production, enabling integral imaging–based light field displays to stand out among various light field display solutions. However, when integral imaging light field displays are used to provide floating stereoscopic display effects, the focusing capability of light decreases as the floating display distance increases, leading to image blur and reduced imaging resolution. Consequently, stereoscopic images generated using integral imaging light field displays are generally limited to regions close to the display panel in order to achieve optimal stereoscopic image quality.

A dihedral corner reflector array (DCRA) is a passive optical element capable of completely mirror-projecting an image to the opposite side. Since a single integral imaging light field display is unable to present floating display effects over long distances, combining a DCRA with an integral imaging light field display has become an effective solution. Specifically, the light field display generates a high-quality three-dimensional stereoscopic image at a near distance, and the DCRA then projects the three-dimensional image to a remote location, thereby providing users with an immersive floating display experience. However, due to structural limitations of the DCRA, the viewing angle of the stereoscopic display is relatively narrow, which restricts the range of potential application scenarios for this technology.

### SUMMARY

To address the aforementioned limitation of a narrow viewing angle, the present invention provides a floating stereoscopic display device that integrates a plurality of floating display modules. Different modules are configured to provide different viewing-angle information, thereby enabling a wide-viewing-angle floating stereoscopic image and expanding the application scope of the technology.

The present invention provides a floating stereoscopic display device including a plurality of floating display modules disposed adjacent to each other. Each of the plurality of floating display modules includes an image processor, and the image processor of each of the plurality of floating display modules provides respective stereoscopic image data. The stereoscopic image data provided by each of the image processors is generated in response to different simulated viewing angle ranges of reference image data. Each of the plurality of floating display modules projects a stereoscopic image in a corresponding one of a plurality of stereoscopic display spaces according to the respective stereoscopic image data. The plurality of stereoscopic display spaces are at least partially overlapped to form a stereoscopic imaging space, and the stereoscopic images projected by the plurality of floating display modules in the stereoscopic imaging space are combined to form a floating stereoscopic image.

In one embodiment, each of the plurality of floating display modules includes a focal plane, and the focal planes of the plurality of floating display modules are intersected in an axis, and the axis is a rotational symmetry axis of the stereoscopic imaging space.

In one embodiment, the axis has a reference coordinate point, and each of the stereoscopic images is projected in the stereoscopic imaging space according to the reference coordinate point.

In one embodiment, each of the plurality of floating display modules includes a light field display and a reflective projection element, and for each of the plurality of floating display modules, the stereoscopic image is projected from the light field display to the corresponding one of the plurality of stereoscopic display spaces through the reflective projection element. The reflective projection elements of the plurality of floating display modules are disposed adjacent to each other.

In one embodiment, for each of the plurality of floating display modules, a portion of the floating display module adjacent to the reflective projection element includes a light-absorbing material or an opaque material.

In one embodiment, each of the plurality of floating display modules includes a first coupling surface and a second coupling surface, and the plurality of floating display modules are adjacently spliced to each other through the first coupling surfaces and the second coupling surfaces of the plurality of floating display modules.

In one embodiment, for each of the plurality of floating display modules, the first coupling surface and the second coupling surface include a light-absorbing material or an opaque material.

In one embodiment, the first coupling surface and the second coupling surface correspondingly spliced to each other are completely overlapped.

In one embodiment, for each of the plurality of floating display modules, an included angle is formed between the first coupling surface and the second coupling surface. The plurality of floating display modules are arranged adjacent to each other around the stereoscopic imaging space based on the included angle of each of the plurality of floating display modules.

In one embodiment, each of the plurality of floating display modules has an emergence angle to provide a viewpoint region, and the viewpoint regions of the plurality of floating display modules are at least partially overlapped to form a continuous viewpoint region.

In one embodiment, for each of the plurality of floating display modules, the included angle is smaller than the emergence angle.

In one embodiment, the plurality of floating display modules include a first floating display module and a second floating display module respectively forming an angle with a reference plane, and the continuous viewpoint region at least partially overlaps with the stereoscopic imaging space.

In one embodiment, for each of the plurality of floating display modules, the angle is smaller than the emergence angle.

In one embodiment, the angle is between 12.5 degrees and 17.5 degrees, and the emergence angle is between 40 degrees and 45 degrees.

In one embodiment, the plurality of floating display modules include a first floating display module, a second floating display module, and a third floating display module. The first floating display module and the third floating display module respectively form an angle with a reference plane, and the continuous viewpoint region at least partially overlaps with the stereoscopic imaging space, and a surface of the second floating display module is coincident with the reference plane.

In one embodiment, for each of the plurality of floating display modules, the angle is smaller than the emergence angle.

In one embodiment, the angle is between 25 degrees and 35 degrees, and the emergence angle is between 40 degrees and 45 degrees.

In one embodiment, the different simulated viewing angle ranges of the reference image data include a plurality of horizontal angle ranges, and each of the stereoscopic image data provided by each of the image processors is generated in response to each of the plurality of horizontal angle ranges.

In one embodiment, the plurality of floating display modules include a first floating display module, a second floating display module, and a third floating display module, and the plurality of horizontal angle ranges include a first horizontal angle range, a second horizontal angle range, and a third horizontal angle range.

In one embodiment, the first horizontal angle range is from -50 degrees to -5 degrees, the second horizontal angle range is from -22.5 degrees to 22.5 degrees, and the third horizontal angle range is from 5 degrees to 50 degrees.

### BRIEF DESCRIPTION OF THE DRAWINGS

FIGS. 1A to 1K are schematic diagrams of a floating stereoscopic display device and floating display modules thereof in one embodiment of the present invention.

FIGS. 1L and 1M are respectively enlarged schematic diagrams of the floating stereoscopic display device and floating display modules thereof corresponding to FIGS. 1K and 1J.

FIGS. 2A to 2B are schematic diagrams of a floating stereoscopic display device and a stereoscopic imaging space provided thereby in one embodiment of the present invention.

FIG. 3 is a schematic diagram of a floating stereoscopic display device and a stereoscopic imaging space provided thereby in one embodiment of the present invention.

FIGS. 4A to 4E are schematic diagrams of a floating stereoscopic display device and a stereoscopic imaging space and a continuous viewpoint region provided thereby in one embodiment of the present invention.

FIGS. 5A to 5B are schematic diagrams of a floating stereoscopic display device and a stereoscopic imaging space and a continuous viewpoint region provided thereby in one embodiment of the present invention.

FIGS. 6A to 6D are schematic diagrams of floating stereoscopic display devices having different angles and viewing angles and stereoscopic imaging spaces and continuous viewpoint regions provided thereby in some embodiments of the present invention.

FIGS. 7A to 7D are schematic diagrams of floating stereoscopic display devices having different angles and continuous viewpoint stereoscopic imaging spaces provided thereby in some embodiments of the present invention.

FIGS. 8A to 8D are schematic diagrams of floating stereoscopic display devices having different numbers of floating display modules and stereoscopic imaging spaces provided thereby in some embodiments of the present invention.

FIGS. 9A to 9C are schematic diagrams of a floating stereoscopic display device and the floating stereoscopic images with different viewing angles provided thereby in one embodiment of the present invention.

### DETAILED DESCRIPTION

Any reference herein to elements using names such as “first”, “second”, etc. generally does not limit the number or order of these elements. Rather, these names are used herein as a convenient way to distinguish between two or more elements or instances of elements. Therefore, it should be understood that the names “first,” “second,” etc. in the claims do not necessarily correspond to the same names in the written description. Furthermore, it should be understood that reference to first and second components does not imply that only two components may be employed or that the first component must precede the second component. The words “comprising”, “including”, “has”, “contains”, etc. used herein are all open terms, which mean including but not limited to thereof. The words “exemplary” and/or “example” are used herein to mean “serving as an example, instance, or illustration.” Any aspect described herein as “exemplary” and/or “example” is not necessarily to be construed as preferred or advantageous over other aspects. The terms “about” and “approximately” as used herein with respect to a specified value or characteristic are intended to mean within a certain numerical value (e.g. 10%) of the specified value or characteristic.

Furthermore, relative terminologies, such as “lower” or “bottom” and “upper” or “top” may be used herein to describe the relationship between one element and another element, as shown in the drawings. It should be understood that relative terminologies are intended to encompass different orientations of the device in addition to the orientation shown in the drawings. For instance, if a device in one of the accompanying drawings is turned upside down, elements described as being on the “lower” side of other elements would then be oriented on the “upper” sides of the other elements. Thus, the exemplary terminology “lower” may include an orientation of being on the “lower” side and the “upper” side, depending on the particular orientation of the accompanying drawings. Similarly, if the device in one of the accompanying drawings is turned upside down, elements described as being “below” or “beneath” other elements would then be oriented “above” the other elements. Thus, the exemplary terminology “below” or “beneath” may encompass an orientation of being above and below.

Various embodiments will be described hereinafter, and the spirit and principles of the present invention should be readily understood by those having ordinary skill in the art by reference to the specification and drawings. However, although specific embodiments will be described herein, these embodiments are merely exemplary and are not to be regarded as limiting or exhaustive in any respect. Therefore, to a person having ordinary skill in the art, the changes and modifications to the present invention should be obvious and readily achievable without departing from the spirit and principles of the present invention.

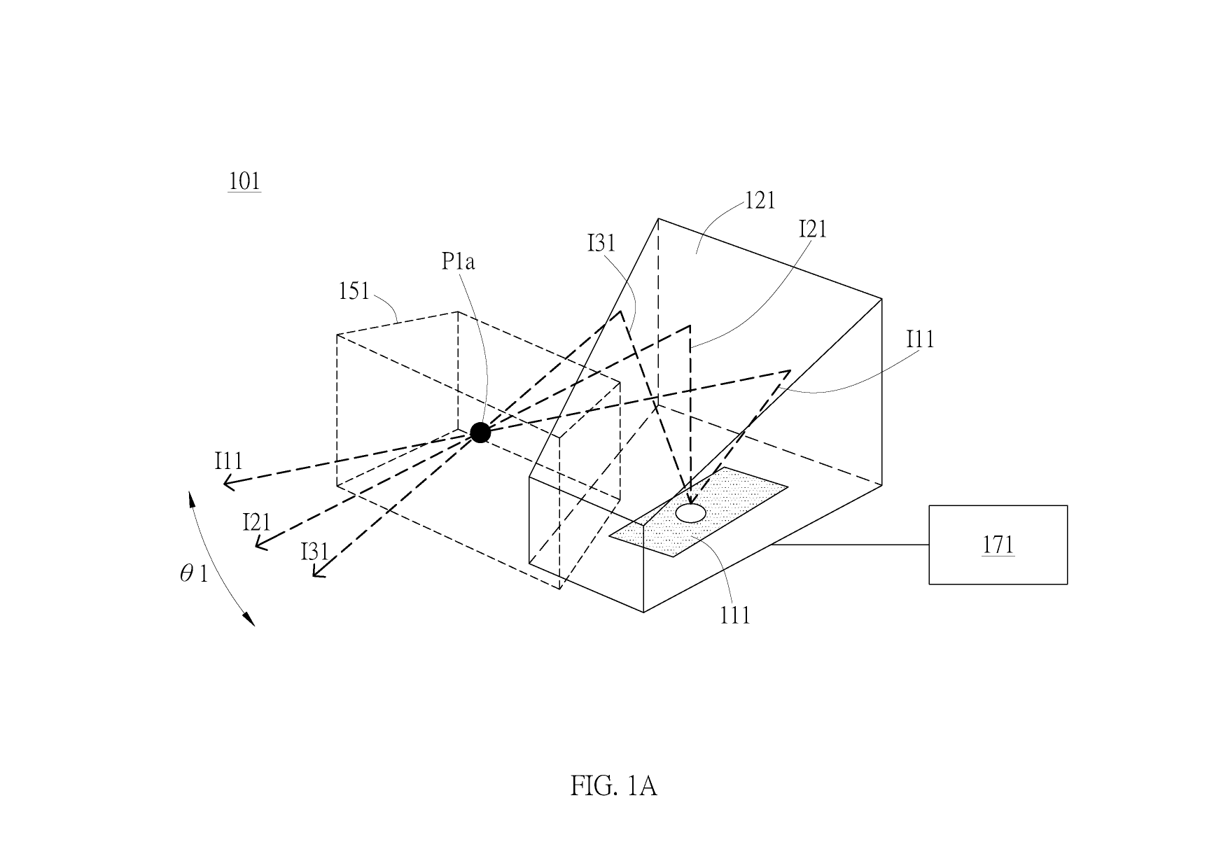

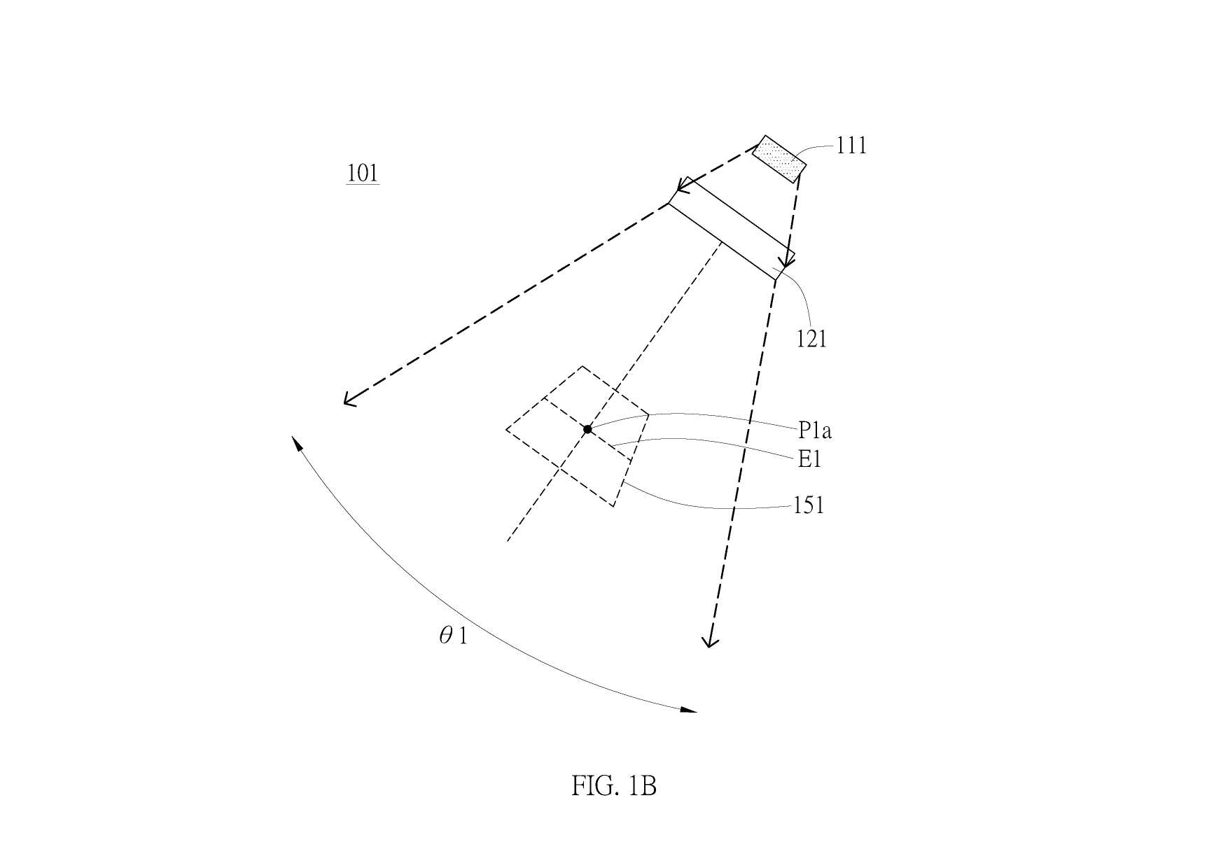

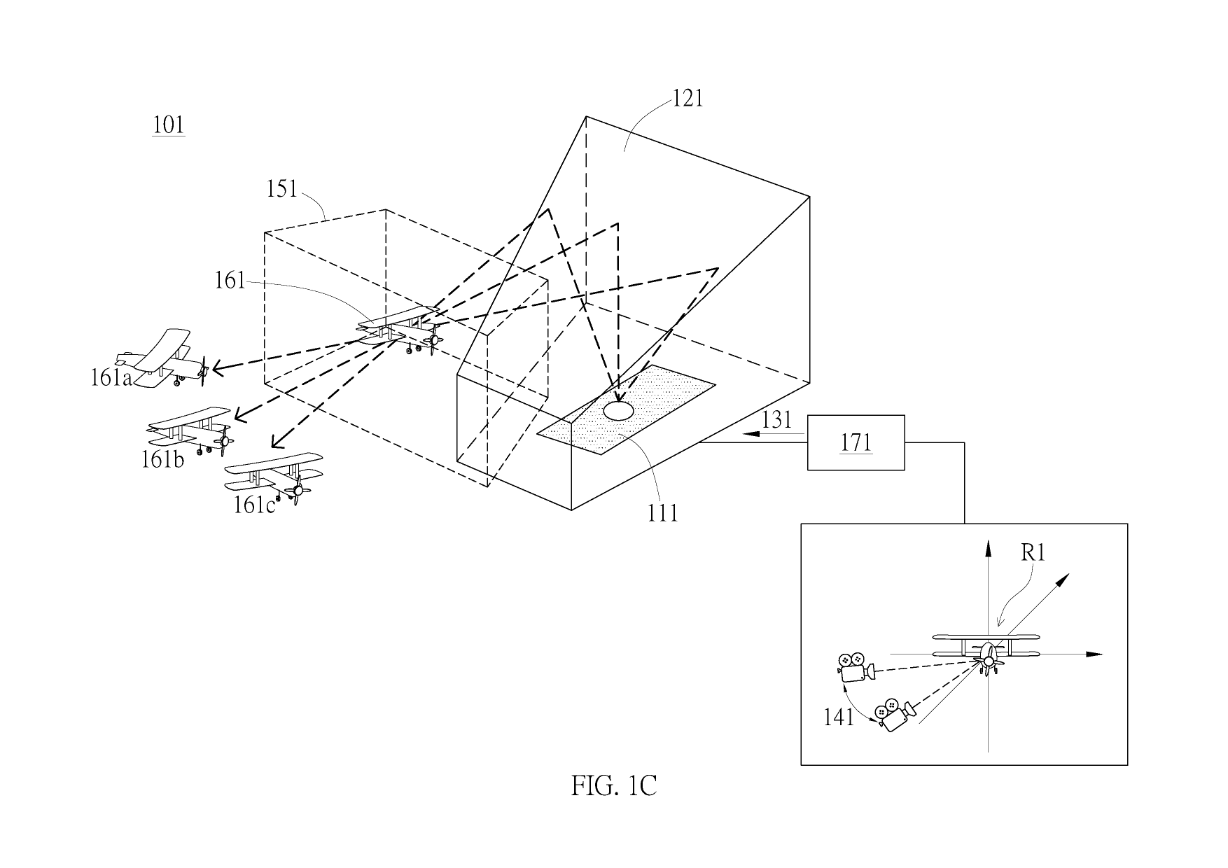

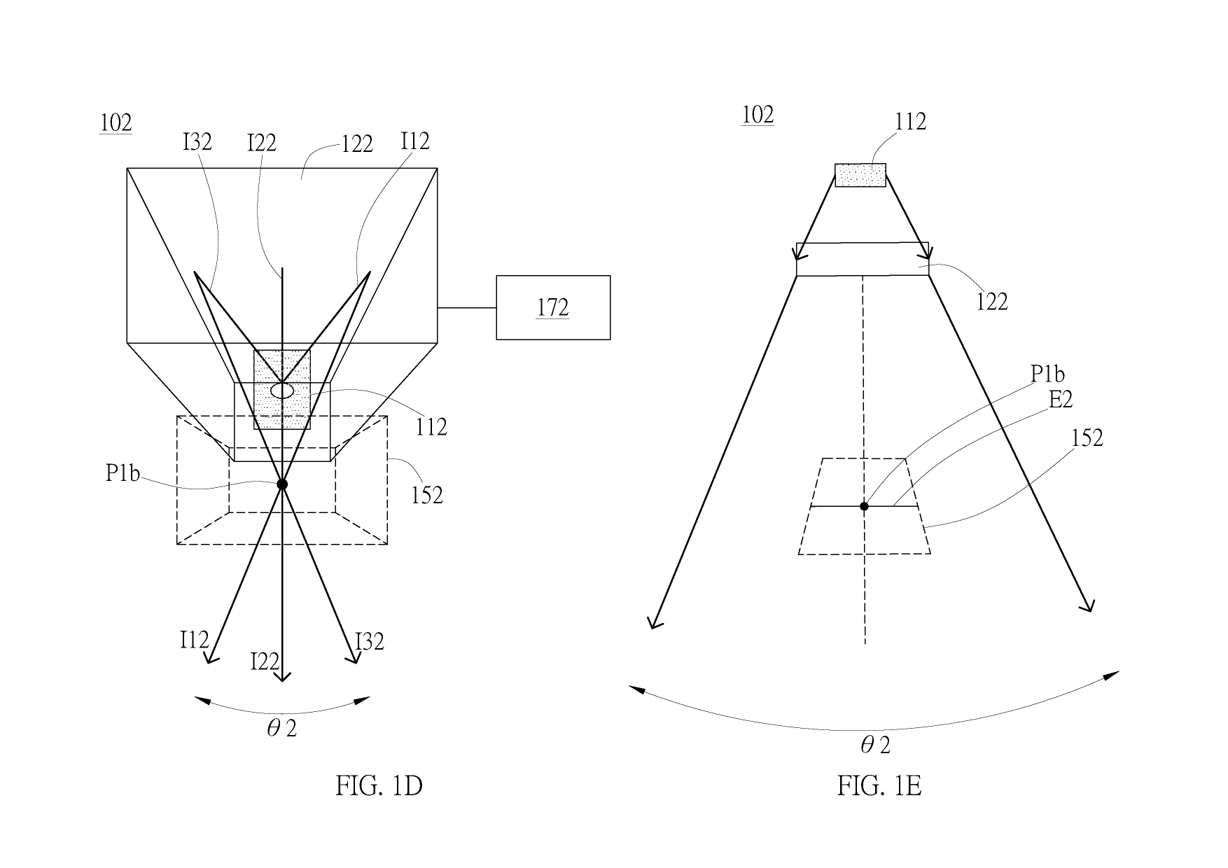

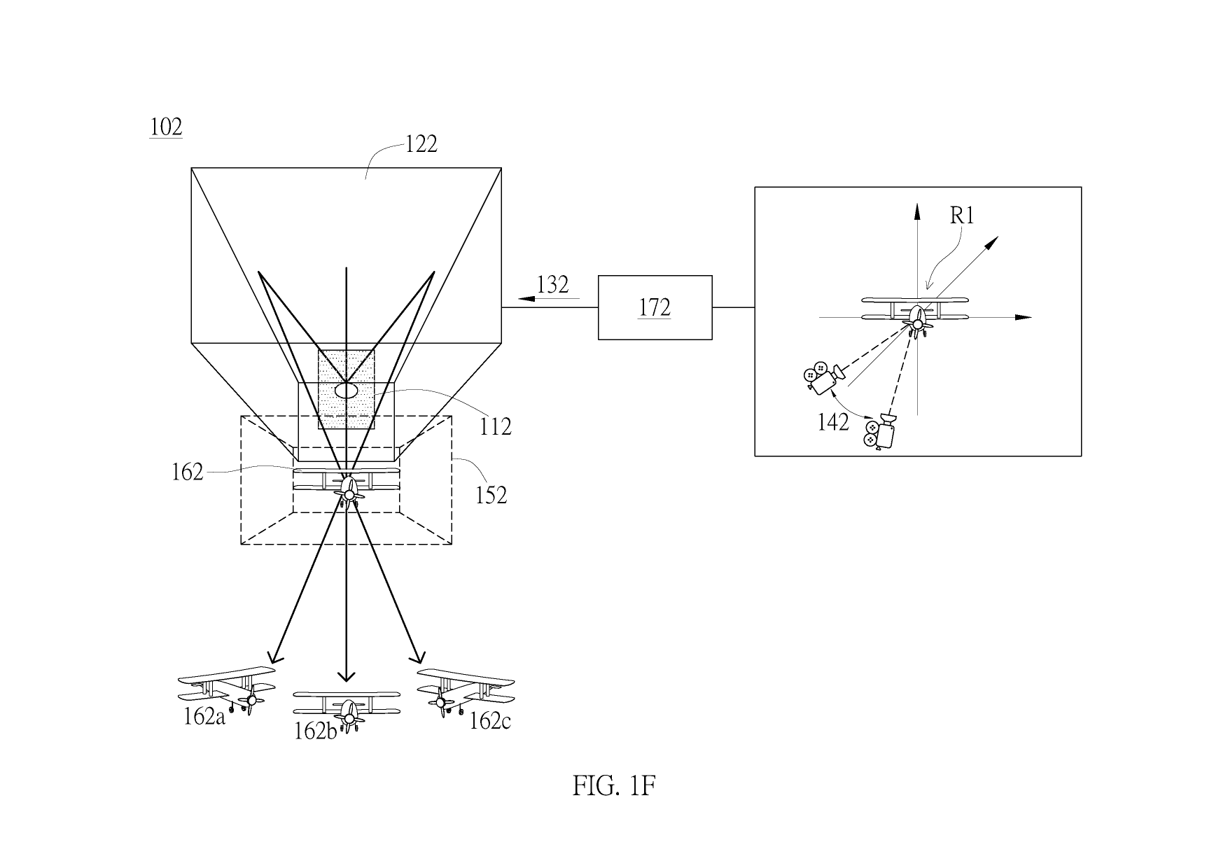

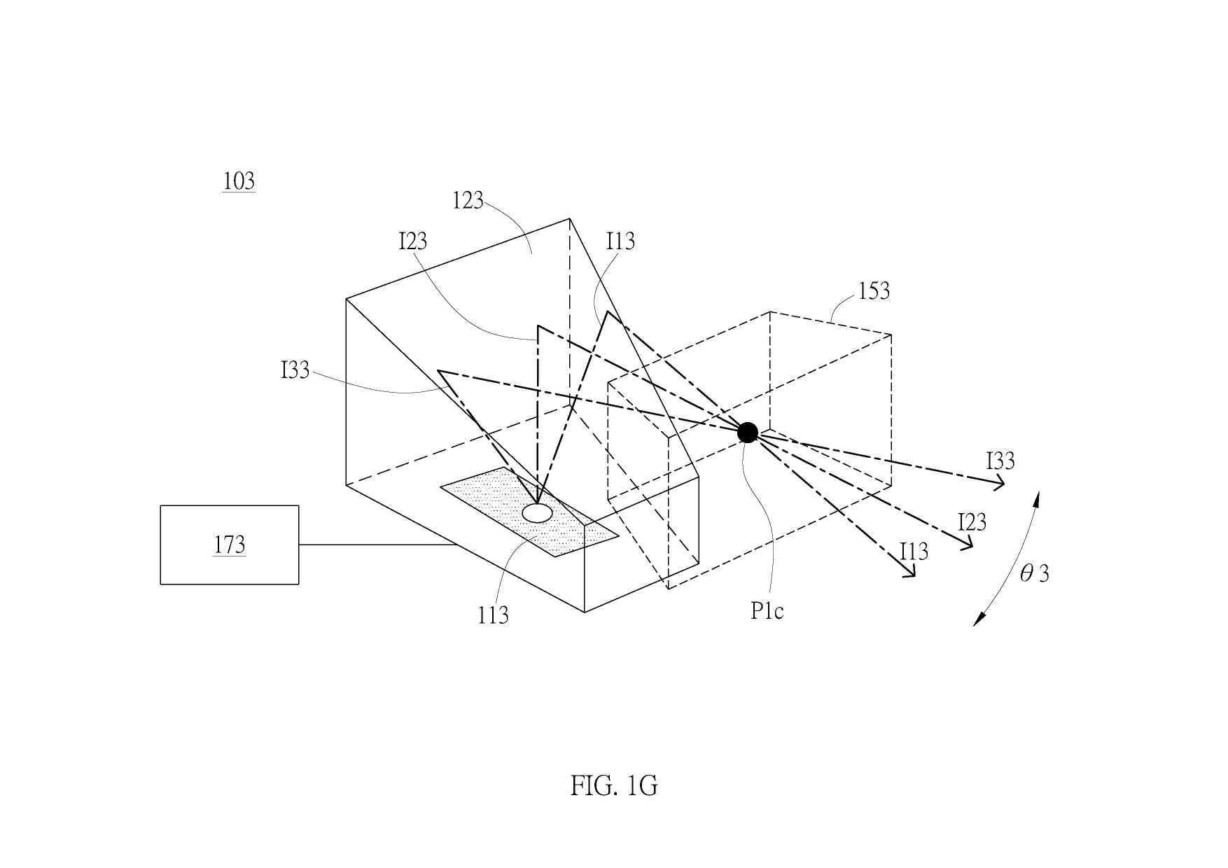

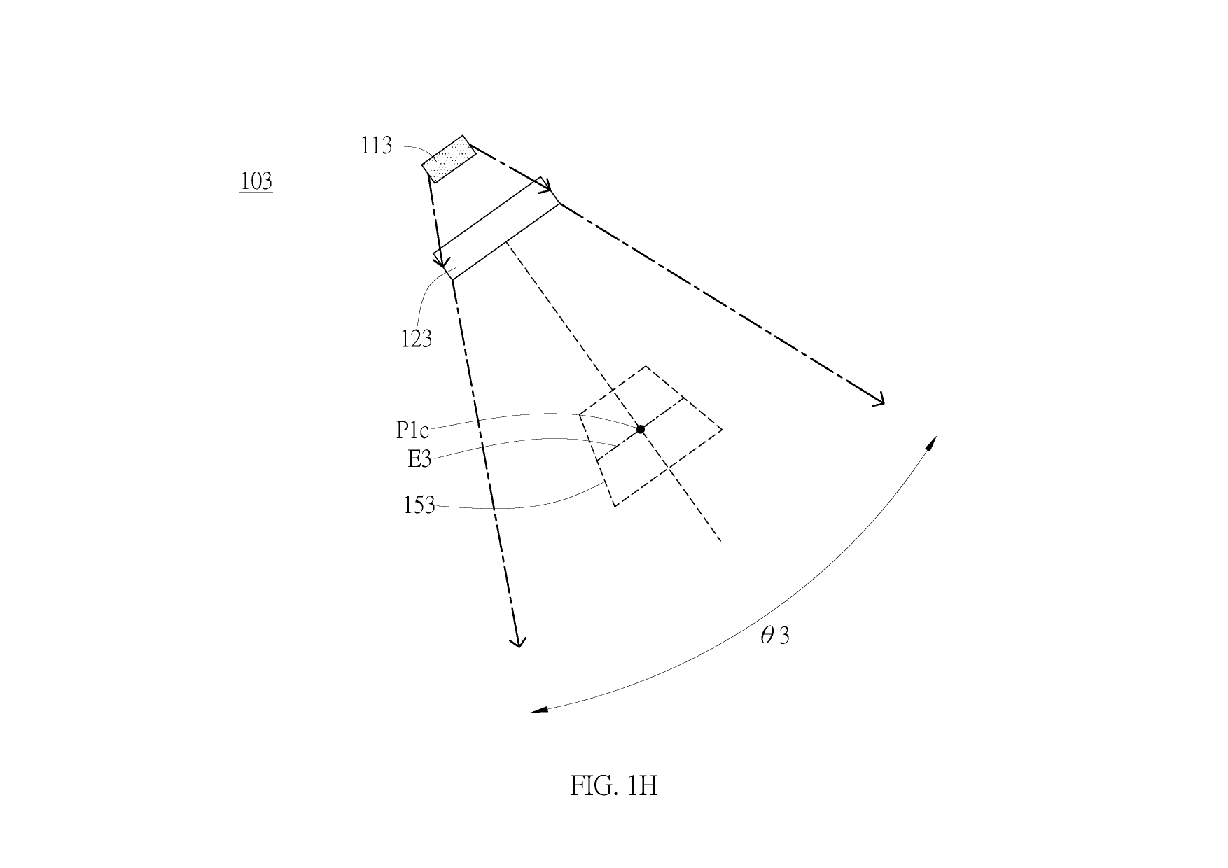

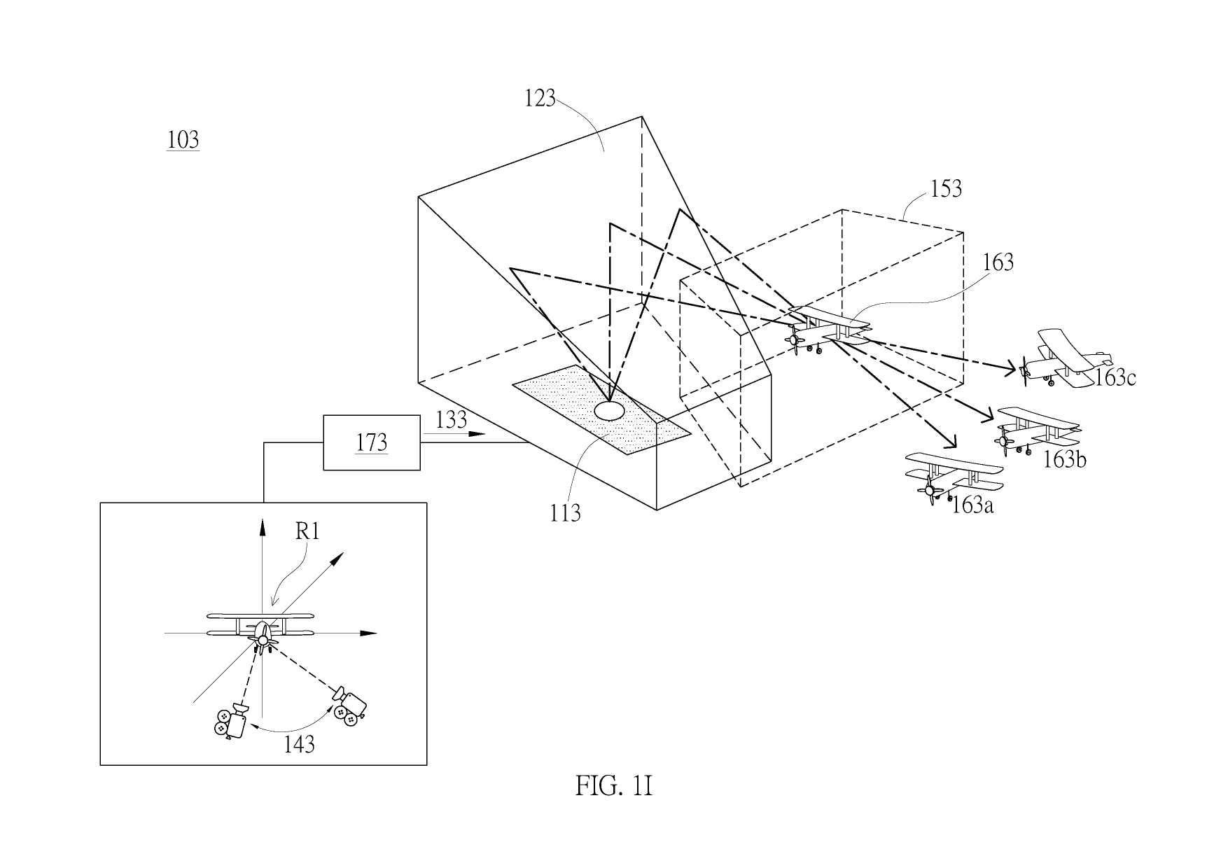

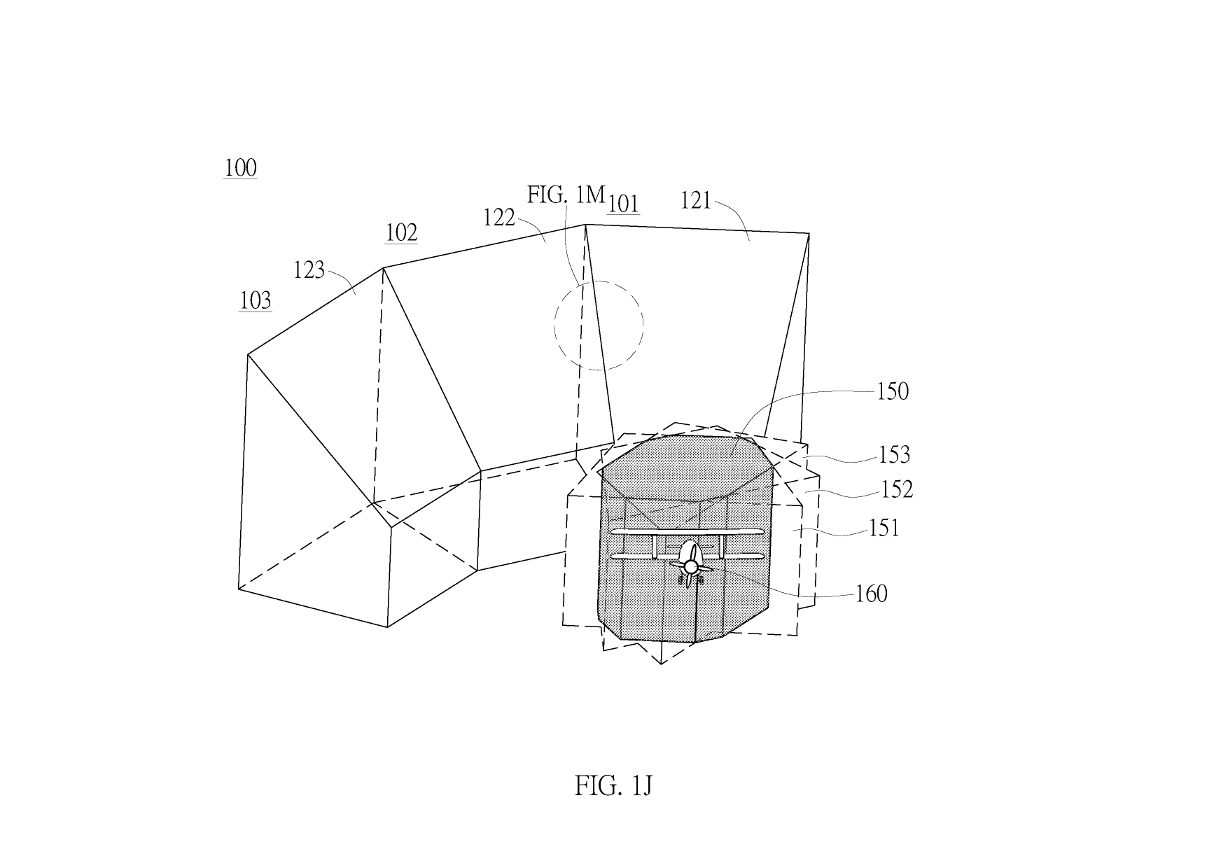

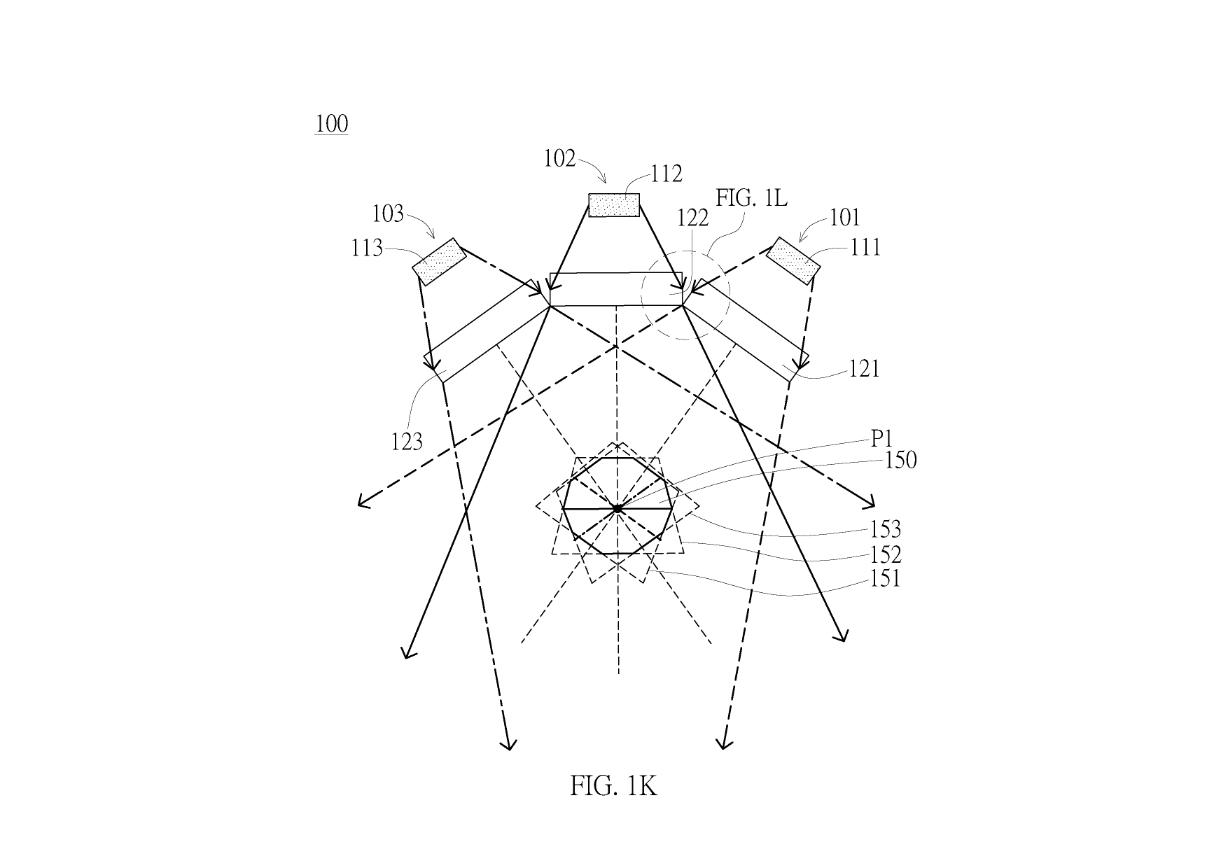

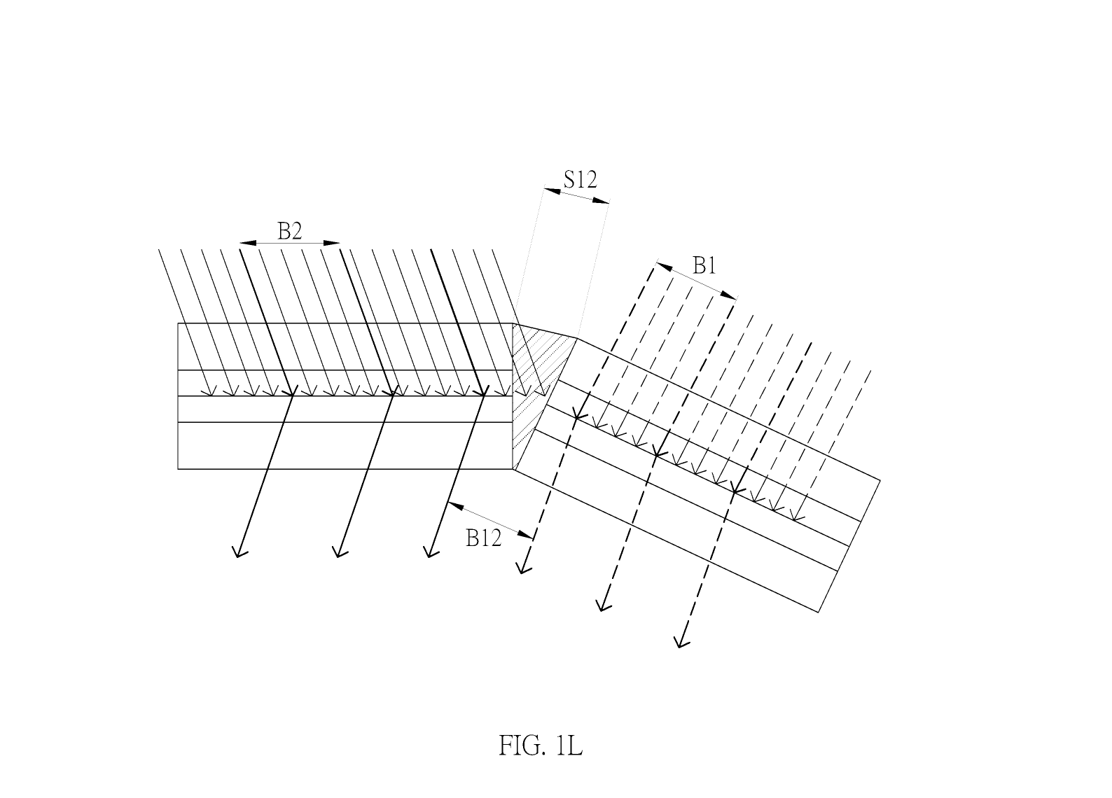

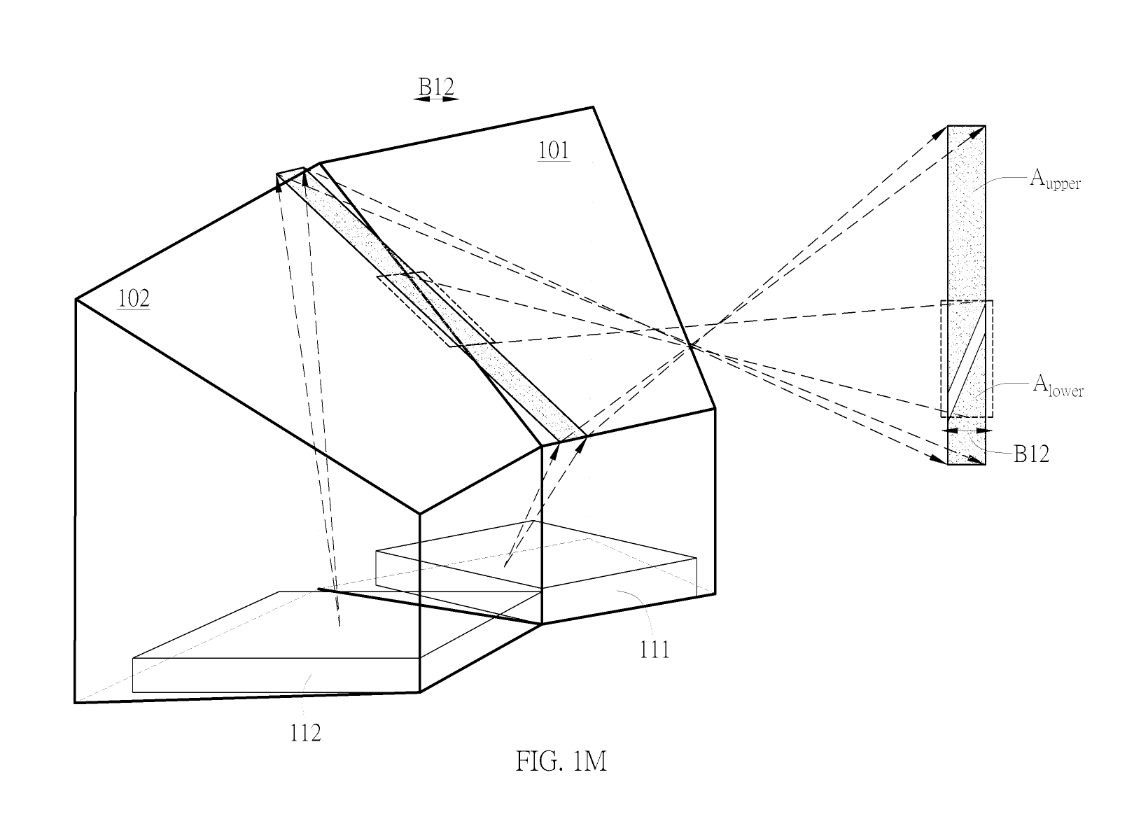

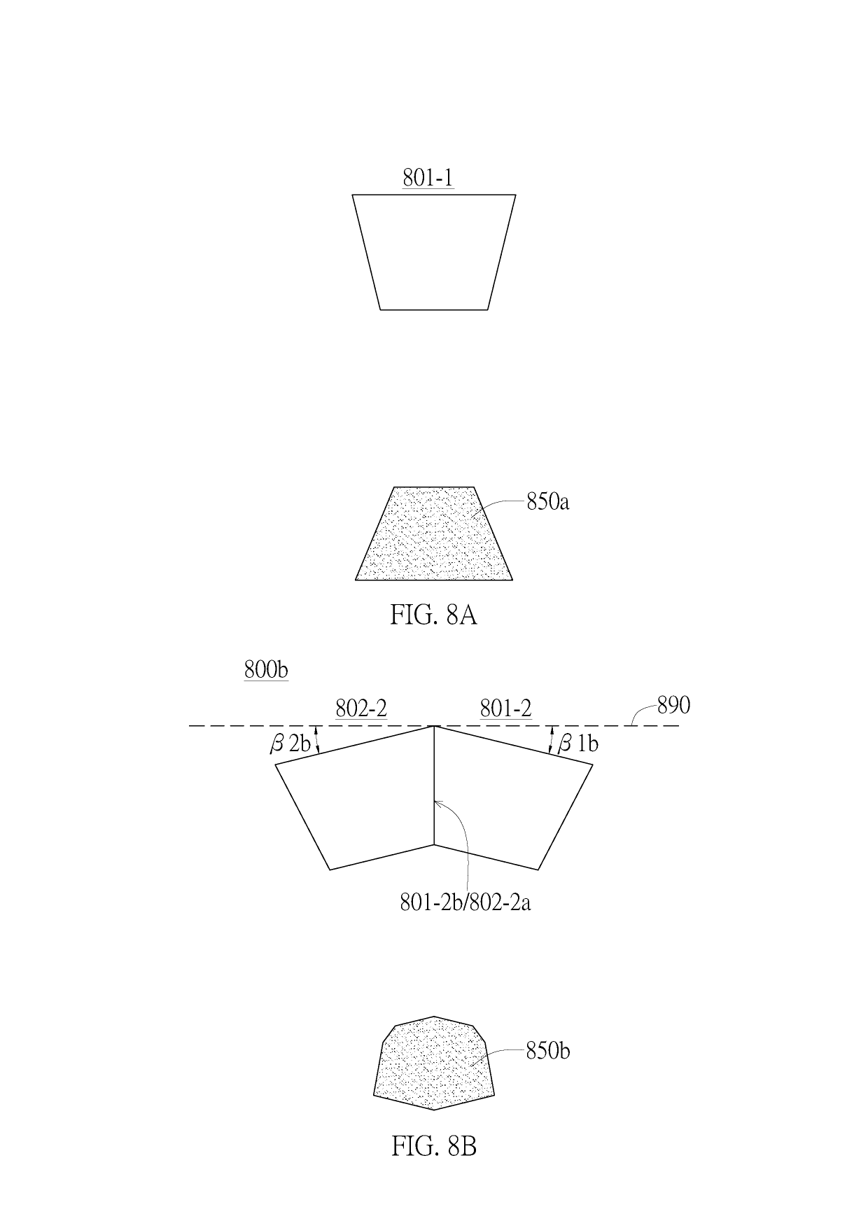

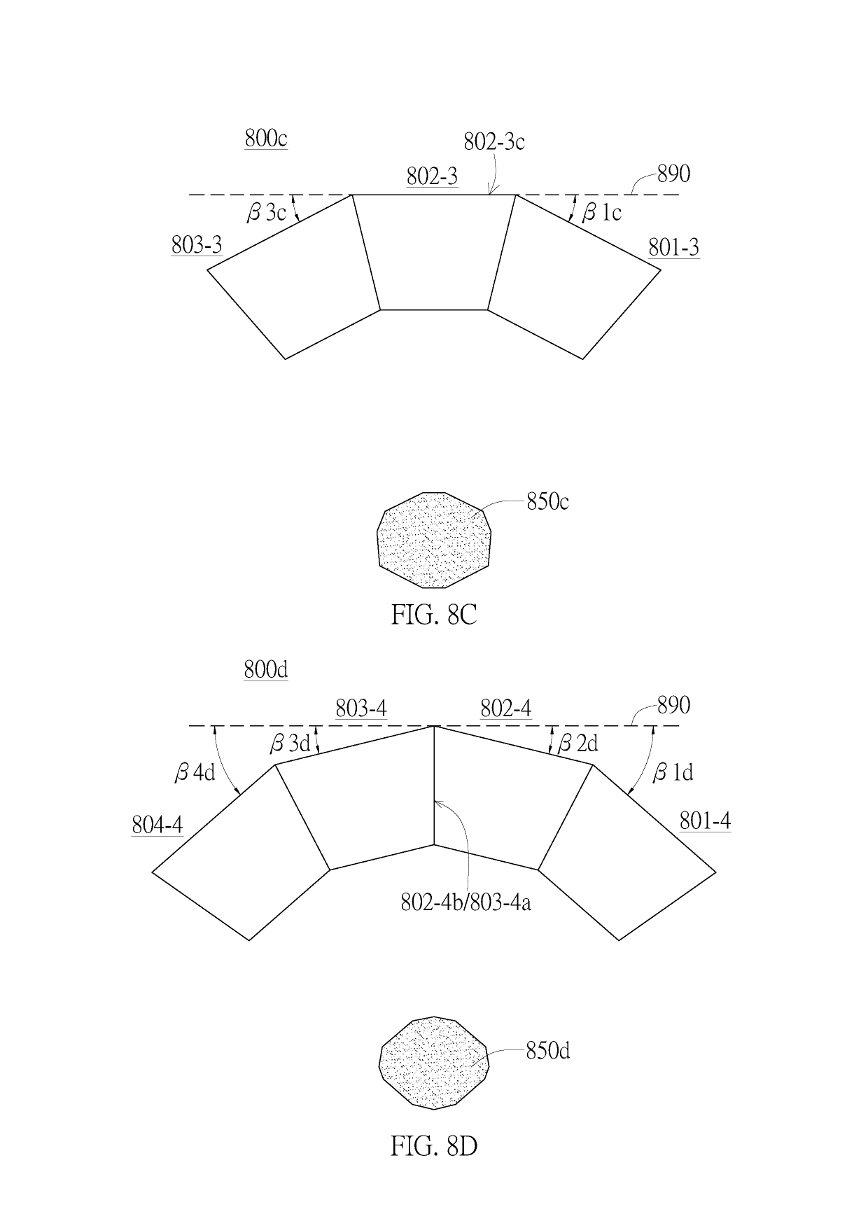

Referring to FIGS. 1A to FIG. 1K, a floating stereoscopic display device 100 disclosed in one embodiment of the present invention includes a first floating display module 101, a second floating display module 102, and a third floating display module 103. However, the present invention is not limited thereto. A plurality of floating display modules may be disposed as needed, such as two or more floating display modules depending on the viewing angle requirements. The quantity is provided merely as an example and is not intended to be limiting. Floating stereoscopic display devices with different numbers of floating display modules will be described in detail in the embodiments shown in FIGS. 8A to 8D.

Referring to FIGS. 1A to FIG. 1C, the first floating display module 101 includes a first image processor 171, which provides first stereoscopic image data 131 to the first floating display module 101. In some embodiments, the stereoscopic image data is generated in response to a simulated viewing angle range of reference image data. The range of simulated viewing angle can be modified according to the projection requirements, such as generating stereoscopic image data at horizontal, vertical, or oblique angles. Specifically, reference image data can be rendered in a virtual space using 3D graphics software. Virtual cameras positioned at multiple angles can capture images from the desired perspectives, and the images are then processed by an image processor to generate corresponding stereoscopic image data. However, the present invention is not limited thereto; other methods for generating stereoscopic image data are also applicable. In the embodiment shown in FIG. 1C, the first stereoscopic image data 131 is generated in response to a first horizontal angle range 141 of reference image data R1, where the first horizontal angle range 141 is from -50 degrees to -5 degrees. These values are provided merely as examples and are not intended to be limiting; the capture direction and angle range can be modified according to the projection requirements.

Referring to FIGS. 1A to FIG. 1C, the first floating display module 101 projects a first stereoscopic image 161 in a first stereoscopic display space 151 according to the first stereoscopic image data 131. In the embodiment shown in FIGS. 1A to 1C, the first floating display module 101 includes a first light field display 111 and a first reflective projection element 121, and the first stereoscopic image 161 is projected from the first light field display 111 to the first stereoscopic display space 151 through the first reflective projection element 121. In some embodiments, the reflective projection element may be a DCRA; however, the present invention is not limited thereto. Any element capable of mirroring the stereoscopic image generated by the light field display to the stereoscopic display space is applicable. In the embodiment shown in FIGS. 1A to 1C, the first reflective projection element 121 forms a 45-degree angle with the first light field display 111. These values are provided merely as examples and are not intended to be limiting; the angle between the reflective projection element and the light field display may be modified according to the projection requirements.

Referring to FIGS. 1A and 1B, the first light field display 111 emits lights generated according to the stereoscopic image data provided by the first image processor 171 via a first light path I11, a second light path I21, and a third light path I31. These lights are projected to the first stereoscopic display space 151 through the first reflective projection element 121 to form a stereoscopic image. The number of light paths shown here is merely illustrative. Specifically, the first light path I11 represents the leftmost light beam projectable by the first floating display module 101, the second light path I21 represents the middle light beam projectable by the first floating display module 101, and the third light path I31 represents the rightmost light beam projectable by the first floating display module 101. The three light paths converge at a first focal point P1a within the first stereoscopic display space 151, and the angle between the first light path I11 and the third light path I31 constitutes a first emergence angle θ1 of the first floating display module 101. As shown in FIG. 1B, the maximum angle between the light paths at two sides projected by the first floating display module 101 constitutes the first emergence angle θ1 of the first floating display module 101. In some embodiments, the emergence angle of each light field display should be consistent with the corresponding emergence angle of the reflective projection element to avoid ghosting. For illustrative convenience, the emergence angles described herein are depicted in the horizontal direction. However, those skilled in the art will recognize that the emergence angle of the floating display module is a solid angle.

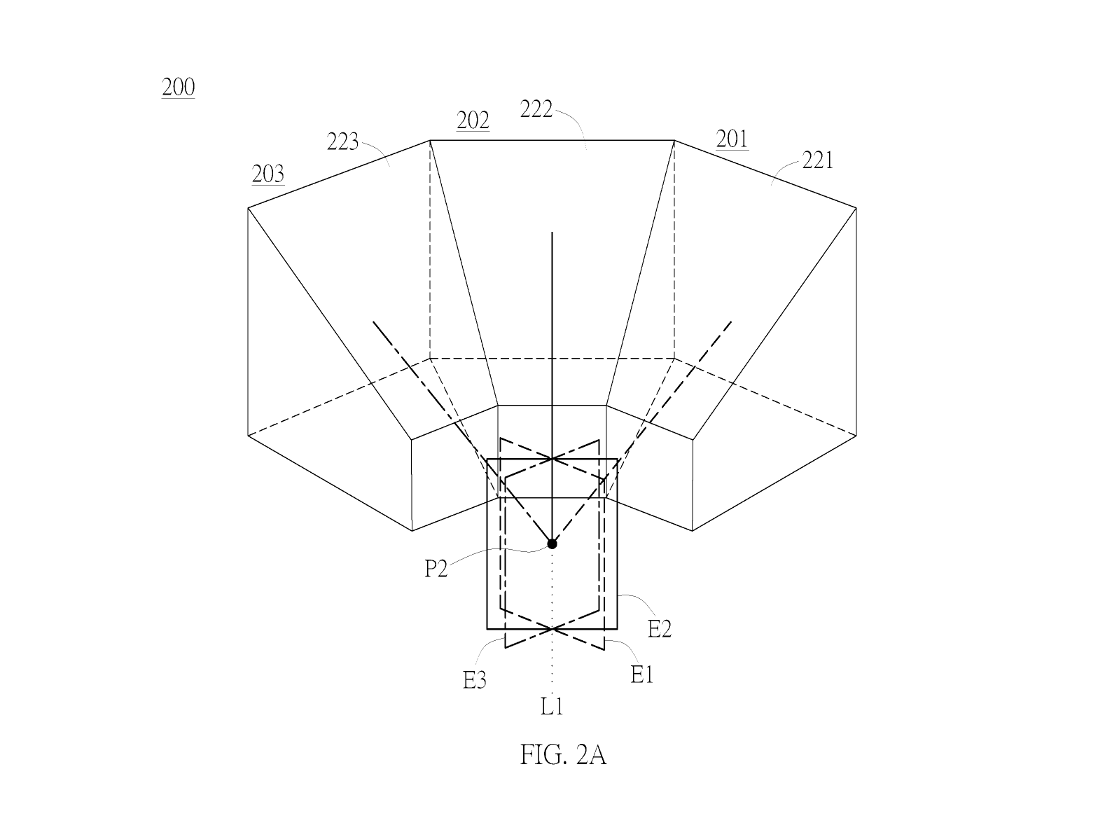

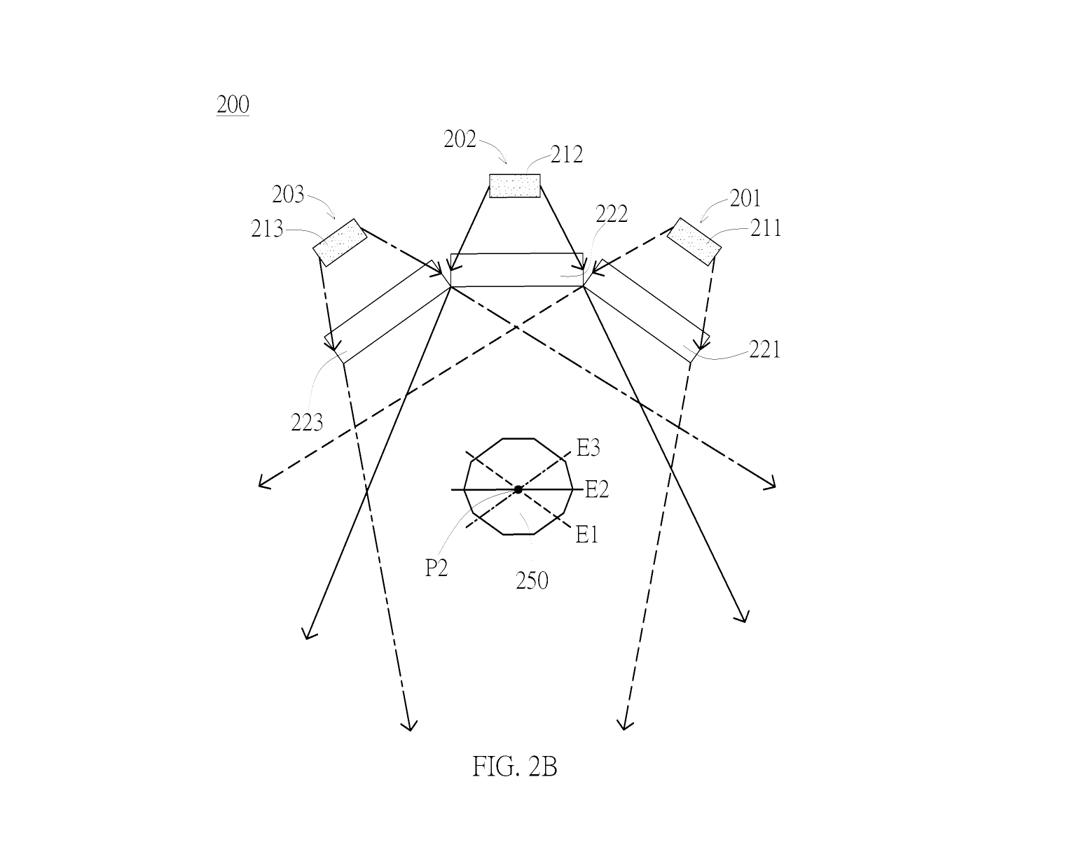

Referring to FIG. 1B, the first floating display module 101 includes a first focal plane E1. Specifically, within a certain depth of focus (DOF) range in front of and behind the focal plane, it constitutes the optimal range for displaying stereoscopic images. As illustrated in FIG. 1B, the top view of the first stereoscopic imaging space 151 forms a trapezoid. This trapezoid delineates the range centered on the first focal plane E1 with a specified depth of focus before and after it, where the first focal point P1a lies on the first focal plane E1. In the embodiment shown in FIG. 1B, the first light field display 111 possesses a depth of focus range (not shown), which is mapped equidistantly to the opposite side of the first reflective projection element 121, thereby forming the first stereoscopic imaging space 151. The floating display module and focal plane will be described in detail in the embodiments shown in FIGS. 2A to 2B.

Referring to FIG. 1C, the first light field display 111 emits lights generated according to the first stereoscopic image data 131 provided by the first image processor 171 via the first light path I11, the second light path I21, and the third light path I31 shown in FIG. 1A. These lights are projected through the first reflective projection element 121 to the first stereoscopic display space 151 to form projected portions, such as the first stereoscopic images 161a, 161b, and 161c, respectively. The stereoscopic images generated in all light paths will overlap to form the first stereoscopic image 161 in the first stereoscopic display space 151. Specifically, the first stereoscopic images 161a, 161b, and 161c correspond to different angles within the first horizontal angle range 141 of the first stereoscopic image data 131 in response to the reference image data R1.

Referring to FIGS. 1D to FIG. 1F, the second floating display module 102 includes a second image processor 172, which provides second stereoscopic image data 132 to the second floating display module 102. In the embodiment shown in FIG. 1F, the second stereoscopic image data 132 is generated in response to a second horizontal angle range 142 of the reference image data R1, wherein the second horizontal angle range 142 is different from the first horizontal angle range 141 shown in FIG. 1C. In some embodiments, the second horizontal angle range 142 may overlap with the first horizontal angle range 141. In the embodiment shown in FIG. 1F, the second horizontal angle range 142 is from -22.5 degrees to 22.5 degrees. These values are provided merely as examples and are not intended to be limiting; the capture direction and angle range can be modified according to the projection requirements.

Referring to FIGS. 1D to FIG. 1F, the second floating display module 102 projects a second stereoscopic image 162 in a second stereoscopic display space 152 according to the second stereoscopic image data 132. In the embodiment shown in FIGS. 1D to 1F, the second floating display module 102 includes a second light field display 112 and a second reflective projection element 122, and the second stereoscopic image 162 is projected from the second light field display 112 to the second stereoscopic display space 152 through the second reflective projection element 122. In the embodiment shown in FIGS. 1D to 1F, the second reflective projection element 122 forms a 45-degree angle with the second light field display 112. These values are provided merely as examples and are not intended to be limiting; the angle between the reflective projection element and the light field display may be modified according to the projection requirements.

Referring to FIGS. 1D and 1E, the second light field display 112 emits lights generated according to the stereoscopic image data provided by the second image processor 172 via a first light path I12, a second light path I22, and a third light path I32. These lights are projected to the second stereoscopic display space 152 through the second reflective projection element 122 to form a stereoscopic image. The number of light paths shown here is merely illustrative. Specifically, the first light path I12 represents the leftmost light beam projectable by the second floating display module 102, the second light path I22 represents the middle light beam projectable by the second floating display module 102, and the third light path I32 represents the rightmost light beam projectable by the second floating display module 102. The three light paths converge at a second focal point P1b within the second stereoscopic display space 152, and the angle between the first light path I12 and the third light path I32 constitutes a second emergence angle θ2 of the second floating display module 102. As shown in FIG. 1E, the maximum angle between the light paths at two sides projected by the second floating display module 102 constitutes the second emergence angle θ2 of the second floating display module 102.

Referring to FIG. 1E, the second floating display module 102 includes a second focal plane E2. Specifically, within a certain depth of focus (DOF) range in front of and behind the focal plane, it constitutes the optimal range for displaying stereoscopic images. As illustrated in FIG. 1E, the top view of the second stereoscopic imaging space 152 forms a trapezoid. This trapezoid delineates the range centered on the second focal plane E2 with a specified depth of focus before and after it, where the second focal point P1b lies on the second focal plane E2. In the embodiment shown in FIG. 1E, the second light field display 112 possesses a depth of focus range (not shown), which is mapped equidistantly to the opposite side of the second reflective projection element 122, thereby forming the second stereoscopic imaging space 152. The floating display module and focal plane will be described in detail in the embodiments shown in FIGS. 2A to 2B.

Referring to FIG. 1F, the second light field display 112 emits lights generated according to the second stereoscopic image data 132 provided by the second image processor 172 via the first light path I12, the second light path I22, and the third light path I32 shown in FIG. 1D. These lights are projected through the second reflective projection element 122 to the second stereoscopic display space 152 to form projected portions, such as the second stereoscopic images 162a, 162b, and 162c, respectively. The stereoscopic images generated in all light paths will overlap to form the second stereoscopic image 162 in the second stereoscopic display space 152. Specifically, the second stereoscopic images 162a, 162b, and 162c correspond to different angles within the second horizontal angle range 142 of the second stereoscopic image data 132 in response to the reference image data R1.

Referring to FIGS. 1G to FIG. 1I, the third floating display module 103 includes a third image processor 173, which provides third stereoscopic image data 133 to the third floating display module 103. In the embodiment shown in FIG. 1I, the third stereoscopic image data 133 is generated in response to a third horizontal angle range 143 of the reference image data R1, wherein the third horizontal angle range 143 is different from the first horizontal angle range 141 shown in FIG. 1C and the second horizontal angle range 142 shown in FIG. 1F. In some embodiments, the third horizontal angle range 143 may overlap with the first horizontal angle range 141 and/or the second horizontal angle range 142. In the embodiment shown in FIG. 1I, the third horizontal angle range 143 is from 5 degrees to 50 degrees. These values are provided merely as examples and are not intended to be limiting; the capture direction and angle range can be modified according to the projection requirements.

Referring to FIGS. 1G to FIG. 1I, the third floating display module 103 projects a third stereoscopic image 163 in a third stereoscopic display space 153 according to the third stereoscopic image data 133. In the embodiment shown in FIGS. 1G to 1I, the third floating display module 103 includes a third light field display 113 and a third reflective projection element 123, and the third stereoscopic image 163 is projected from the third light field display 113 to the third stereoscopic display space 153 through the third reflective projection element 123. In the embodiment shown in FIGS. 1G to 1I, the third reflective projection element 123 forms a 45-degree angle with the third light field display 113. These values are provided merely as examples and are not intended to be limiting; the angle between the reflective projection element and the light field display may be modified according to the projection requirements.

Referring to FIGS. 1G and 1H, the third light field display 113 emits lights generated according to the stereoscopic image data provided by the third image processor 173 via a first light path I13, a second light path I23, and a third light path I33. These lights are projected to the third stereoscopic display space 153 through the third reflective projection element 123 to form a stereoscopic image. The number of light paths shown here is merely illustrative. Specifically, the first light path I13 represents the leftmost light beam projectable by the third floating display module 103, the second light path I23 represents the middle light beam projectable by the third floating display module 103, and the third light path I33 represents the rightmost light beam projectable by the third floating display module 103. The three light paths converge at a third focal point P1c within the third stereoscopic display space 153, and the angle between the first light path I13 and the third light path I33 constitutes a third emergence angle θ3 of the third floating display module 103. As shown in FIG. 1H, the maximum angle between the light paths at two sides projected by the third floating display module 103 constitutes the third emergence angle θ3 of the third floating display module 103.

Referring to FIG. 1H, the third floating display module 103 includes a third focal plane E3. Specifically, within a certain depth of focus (DOF) range in front of and behind the focal plane, it constitutes the optimal range for displaying stereoscopic images. As illustrated in FIG. 1H, the top view of the third stereoscopic imaging space 153 forms a trapezoid. This trapezoid delineates the range centered on the third focal plane E3 with a specified depth of focus before and after it, where the third focal point P1c lies on the third focal plane E3. In the embodiment shown in FIG. 1H, the third light field display 113 possesses a depth of focus range (not shown), which is mapped equidistantly to the opposite side of the third reflective projection element 123, thereby forming the third stereoscopic imaging space 153. The floating display module and focal plane will be described in detail in the embodiments shown in FIGS. 2A to 2B.

Referring to FIG. 1I, the third light field display 113 emits lights generated according to the third stereoscopic image data 133 provided by the third image processor 173 via the first light path I13, the second light path I23, and the third light path I33 shown in FIG. 1G. These lights are projected through the third reflective projection element 123 to the third stereoscopic display space 153 to form projected portions, such as the third stereoscopic images 163a, 163b, and 163c, respectively. The stereoscopic images generated in all light paths will overlap to form the third stereoscopic image 163 in the third stereoscopic display space 153. Specifically, the third stereoscopic images 163a, 163b, and 163c correspond to different angles within the third horizontal angle range 143 of the third stereoscopic image data 133 in response to the reference image data R1.

As described in FIGS. 1A to 1I, the stereoscopic image data disclosed herein are generated in response to different simulated viewing angle ranges of the reference image data. In some embodiments, the different simulated viewing angle ranges of the reference image data include a plurality of horizontal angle ranges, with each of the stereoscopic image data generated in response to each of the respective horizontal angle ranges. In the embodiment shown in FIGS. 1C, 1F, and 1I, the floating stereoscopic display device 100 includes the first floating display module 101, the second floating display module 102, and the third floating display module 103. The plurality of horizontal angle ranges include the first horizontal angle range 141, the second horizontal angle range 142, and the third horizontal angle range 143. The first stereoscopic image data 131, the second stereoscopic image data 132, and the third stereoscopic image data 133 are generated in response to different simulated viewing angle ranges of the reference image data R1, including the first horizontal angle range 141, the second horizontal angle range 142, and the third horizontal angle range 143.

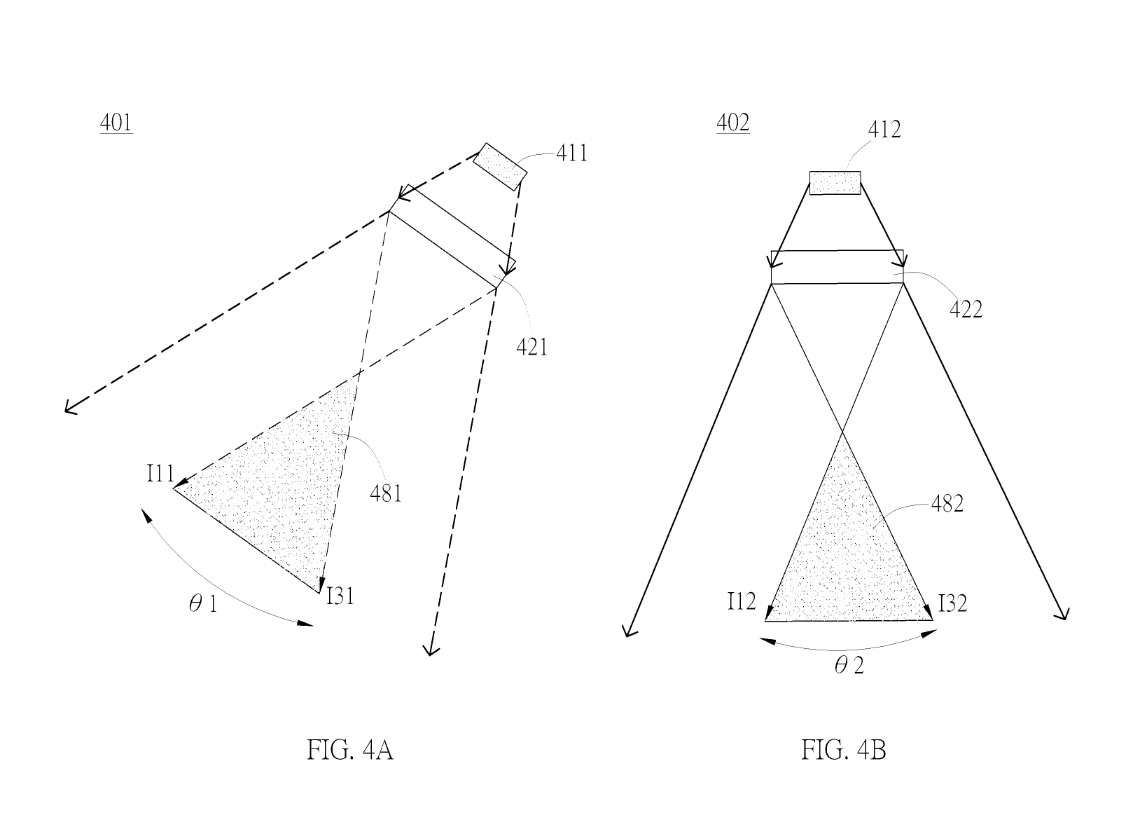

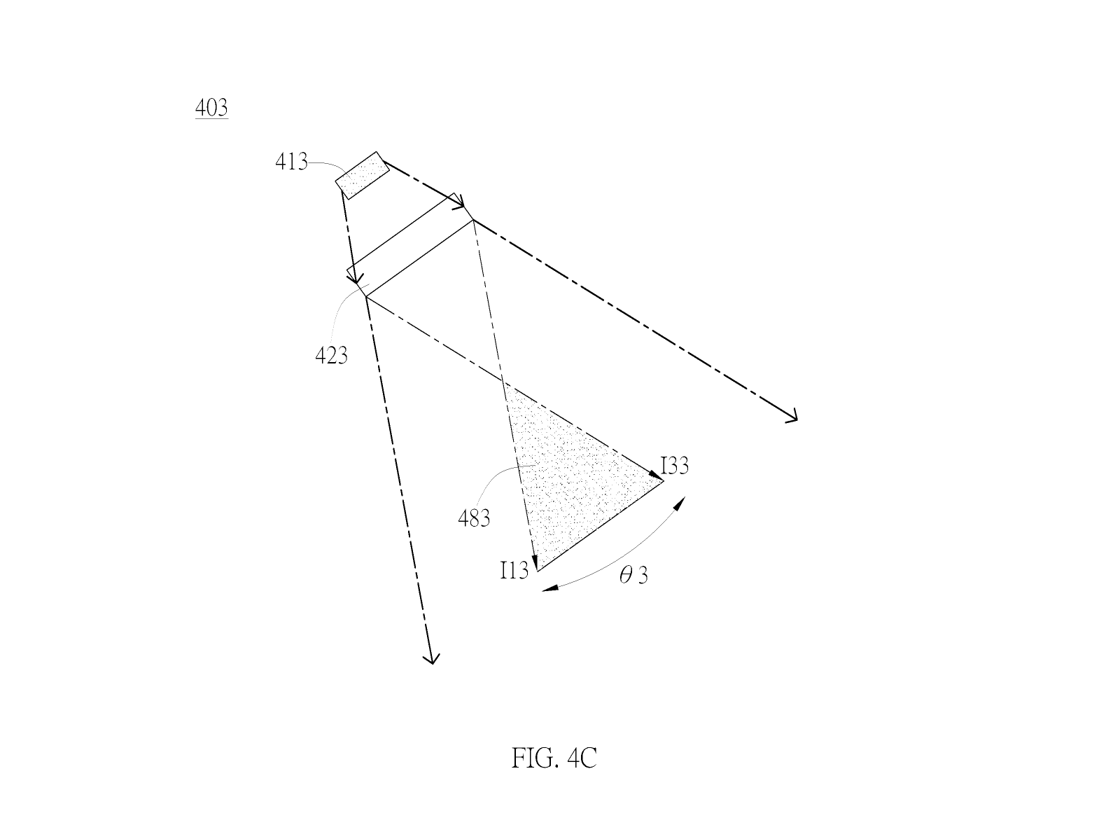

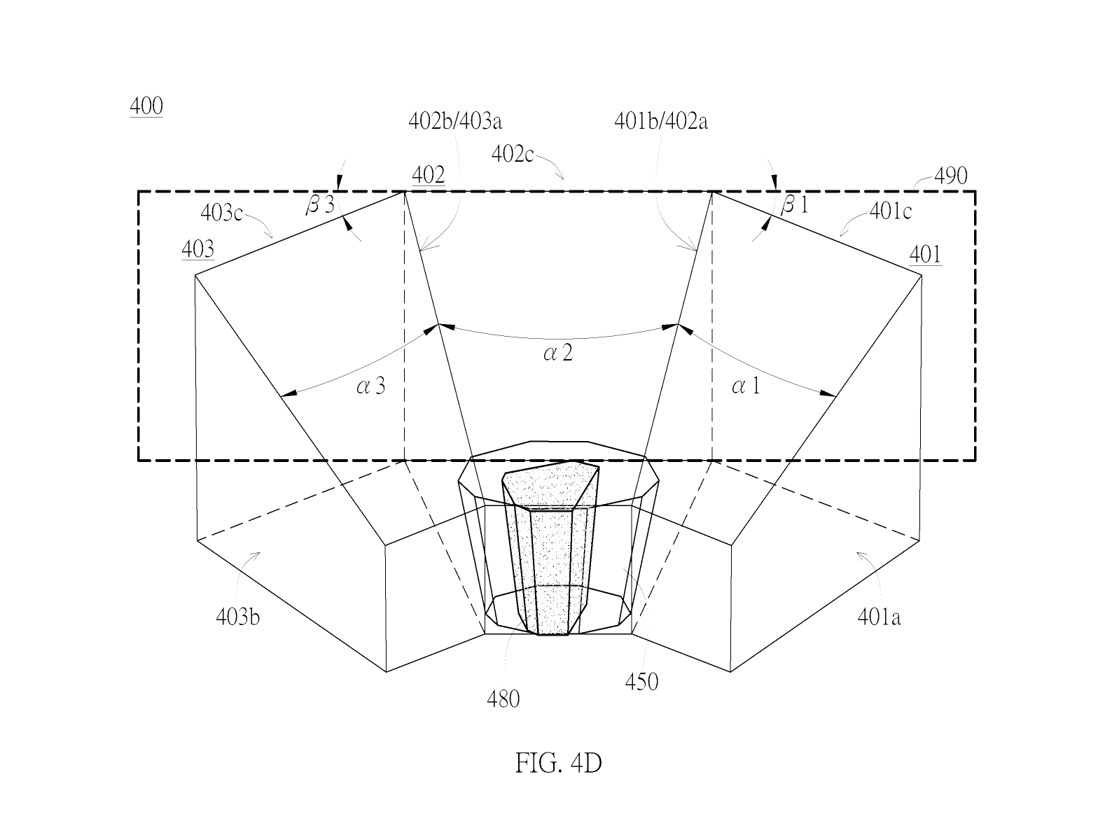

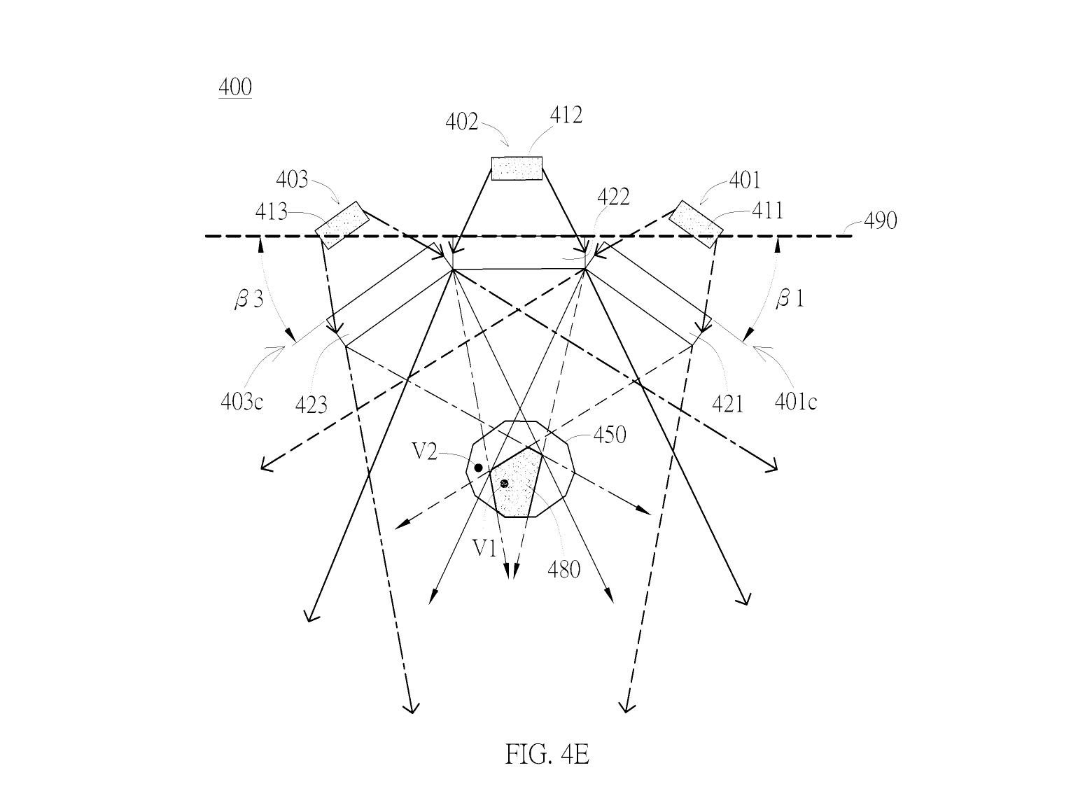

Referring to FIG. 1J, the floating display modules of the floating stereoscopic display device 100 are disposed adjacent to each other. In the embodiment shown in FIG. 1J, the first floating display module 101 is disposed adjacent to the second floating display module 102, and the second floating display module 102 is disposed adjacent to the third floating display module 103. However, the present invention is not limited thereto; various adjacent arrangements are applicable. It is noted that the term “adjacent” as used herein refers to a tightly spliced configuration. This ensures sufficient overlap of the stereoscopic display space and continuity of the viewpoint, thereby providing a wide-angle floating projection effect. The floating display modules and continuous viewpoint will be described in detail in the embodiments shown in FIGS. 4A to 4E.

The present invention employs adjacent arrangement of floating display modules to achieve a wide-angle floating projection effect. Although technical variations may introduce splicing seams between modules, the floating stereoscopic display device of the present invention reduces or even overcomes the impact of such seams on floating stereoscopic imaging. For example, referring to FIG. 1L, a partial enlarged schematic corresponding to FIG. 1K, in the adjacent arrangement of the floating stereoscopic display device of the present invention, the seam gap distance S12 between floating display modules can be maintained within a predetermined value, such as smaller than 1.0 mm. Thus, when calculating the light distance B12 between adjacent viewing angles in the seam area based on an adjacent viewing angle of 0.5 degrees, even if one viewing angle is lost, causing the local adjacent viewing angle to become 1.0 degrees, it still falls within the specifications of the light field display. These values are provided merely as examples and are not intended to be limiting; the size of the seam between the floating display modules can be modified according to the projection requirements. For example, in some embodiments, when the horizontal viewing angle is 53 degrees and the viewpoint is 45 to 100 Views, the light angle interval of adjacent viewing angles can be from 1.18 degrees to 0.53 degrees (calculated as 53 degrees/45 Views or 53 degrees/100 Views). In the embodiment shown in FIG. 1L, when the adjacent viewing angle is 0.5 degrees, the calculated light distance B1 or B2 of adjacent viewing angles in the seam area can be approximately 3.44 mm to 3.46 mm. When the adjacent viewing angle is 1 degrees, the calculated light distance B1 or B2 of adjacent viewing angles in the seam area can be approximately 6.82 mm to 6.90 mm. Furthermore, the light distance between adjacent floating display modules also varies with the viewing angle and the number of viewpoints. For example, in the embodiment shown in FIG. 1L, when the light distance B1 of adjacent viewing angles in the seam area is 3.45 mm and the light distance B2 of adjacent viewing angles is 3.3 mm, the light distance B12 between adjacent floating display modules can be 3.46 mm. These values are provided merely as examples and are not intended to be limiting. Parameters such as the viewing angle, number of viewpoints, and light distance of adjacent viewing angles of the floating display modules may be modified according to the projection requirements.

Furthermore, when a light-emitting surface of a light point at a certain viewing angle on the reflective projection element is not parallel to an extending plane of the seam between the reflective projection element and the floating display module, at most a single stereoscopic angle of viewpoint information will be lost. Since the upper or lower viewing angle information is provided by the same floating display module or adjacent floating display modules, even if the seam between floating display modules causes a single stereoscopic angle information defect, the impact on the floating stereoscopic image is negligible. For example, referring to FIG. 1M, a partial enlargement schematic diagram corresponding to FIG. 1J is illustrated. In the embodiment shown in FIG. 1M, the first light field display 111 and the second light field display 112 respectively emit lights generated according to stereoscopic image data. The upper viewing angle information Aᵤₚₚₑᵣ and the lower viewing angle information A_{lower} are provided respectively by the first floating display module 101 and the adjacent second floating display module 102. As shown in FIG. 1M, the first floating display module 101 and the second floating display module 102 are disposed adjacent to each other with a light distance B12, creating a blank area between the upper viewing angle information Aᵤₚₚₑᵣ and the lower viewing angle information A_{lower}, which constitutes a viewpoint information loss of a single stereoscopic angle. As previously described, the light distance B12 may vary depending on the viewing angle and the number of viewpoints. For example, when the adjacent viewing angle is from 0.5 degrees to 1 degrees, the light distance B12 may be approximately from 3.4 mm to 6.8 mm. Since the upper viewing angle information Aᵤₚₚₑᵣ and the lower viewing angle information A_{lower} are provided by adjacent floating display modules 101 and 102, even with a single stereoscopic angle information loss, the impact on the floating stereoscopic image is negligible and remains within the specifications of the light field display.

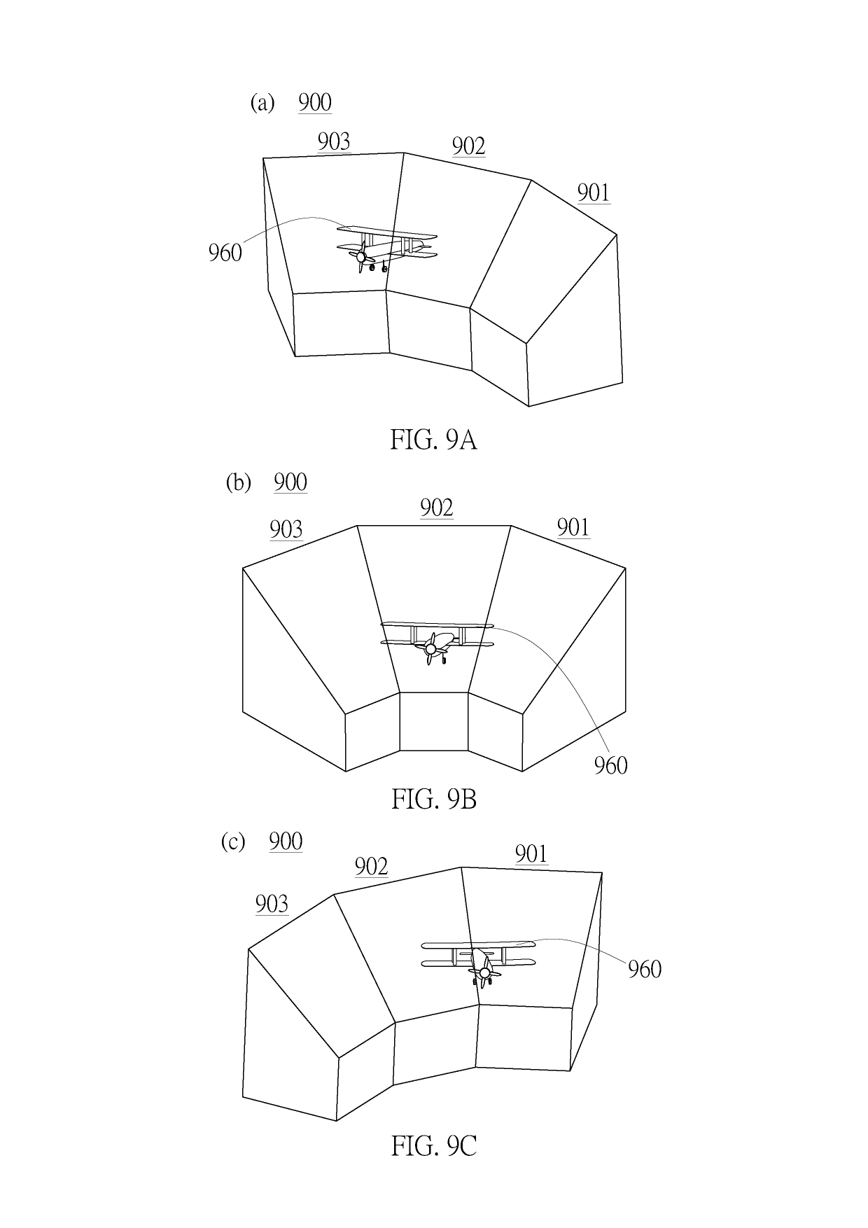

In some embodiments, the plurality of stereoscopic display spaces are at least partially overlapped to form a stereoscopic imaging space, enabling the respective stereoscopic images are combined (overlapped) within the stereoscopic imaging space to form a floating stereoscopic image. In the embodiments shown in FIGS. 1C, 1F, 1I, 1J, and 1K, the overlapping portions of the first stereoscopic display space 151, the second stereoscopic display space 152, and the third stereoscopic display space 153 form a stereoscopic imaging space 150. This allows the first stereoscopic image 161, the second stereoscopic image 162, and the third stereoscopic image 163 are combined (overlapped) within the stereoscopic imaging space 150 to form the floating stereoscopic image 160. The floating stereoscopic display device and the floating stereoscopic images with different viewing angles provided thereby will be described in detail in the embodiments shown in FIGS. 9A to 9C.

In some embodiments, each of the plurality of floating display modules includes a focal point, and the focal points coincide at a reference coordinate point. In the embodiments shown in FIGS. 1B, 1E, 1H, and 1K, the first floating display module 101 includes a first focal point P1a, the second floating display module 102 includes a second focal point P1b, and the third floating display module 103 includes a third focal point P1c. The first focal point P1a, the second focal point P1b, and the third focal point P1c coincide at a reference coordinate point P1. The floating display modules and the reference coordinate point will be described in detail in the embodiments shown in FIGS. 2A to 2B.

In some embodiments, the reflective projection elements are disposed adjacent to each other. In the embodiment shown in FIG. 1J, the first reflective projection element 121 is disposed adjacent to the second reflective projection element 122, and the second reflective projection element 122 is disposed adjacent to the third reflective projection element 123. However, the present invention is not limited thereto. Different adjacent arrangements may be applied. It should be noted that the term “adjacent” as used herein refers to a tightly spliced configuration. This ensures sufficient overlap of the stereoscopic display space and continuity of the viewpoint, thereby providing a wide-angle floating projection effect.

Referring to FIGS. 2A and 2B, a floating stereoscopic display device 200 is disclosed in one embodiment of the present invention, including a first floating display module 201, a second floating display module 202, and a third floating display module 203. The floating stereoscopic display device 200 may be substantially similar to the floating stereoscopic display device 100 shown in FIG. 1J, where like reference numerals indicate like components. For the sake of brevity, detailed descriptions are omitted herein, and the previously described floating stereoscopic display device and its related details are applicable to the present embodiment.

In some embodiments, each of the plurality of floating display modules includes a focal plane, and the focal planes of the plurality of floating display modules are intersected in an axis, and the axis is a rotational symmetry axis of the stereoscopic imaging space. In the embodiment shown in FIGS. 2A and 2B, the first floating display module 201 includes a first focal plane E1, the second floating display module 202 includes a second focal plane E2, and the third floating display module 203 includes a third focal plane E3, where the first focal plane E1, the second focal plane E2, and the third focal plane E3 are intersected in an axis L1, and the axis L1 is a rotational symmetry axis of the stereoscopic imaging space 250. As shown in FIG. 2B, when the stereoscopic imaging space 250 rotates 180 degrees along the axis L1, it coincides with its pre-rotation state, demonstrating rotational symmetry. However, these values are provided merely as examples and are not intended to be limiting. The number of floating display modules, their mutual angles, or the emergence angles may be modified according to the projection requirements to achieve rotational symmetry at different angles. The previously described floating display modules, focal planes, and related details are applicable to the present embodiment.

In the embodiment shown in FIGS. 2A and 2B, the first floating display module 201 includes a first light field display 211 and a first reflective projection element 221, the second floating display module 202 includes a second light field display 212 and a second reflective projection element 222, and the third floating display module 203 includes a third light field display 213 and a third reflective projection element 223. The previously described light field display, reflective projection element, and related details are applicable to the present embodiment.

In one embodiment, the axis has a reference coordinate point, and each of the stereoscopic images is projected in the stereoscopic imaging space according to the reference coordinate point. In the embodiment shown in FIGS. 2A and 2B, the axis L1 has a reference coordinate point P2, and the stereoscopic images projected by the plurality of floating display modules are projected in the stereoscopic imaging space 250 according to the reference coordinate point P2. In the embodiments shown in FIGS. 1C, 1F, 1I, 1J, and 1K, the first stereoscopic image 161, the second stereoscopic image 162, and the third stereoscopic image 163 are projected in the stereoscopic imaging space 150 according to the reference coordinate point P1 and combined (overlapped) to form the floating stereoscopic image 160. The previously described floating display module, focal point, and related details are applicable to the present embodiment.

In summary, the reference coordinate point is formed by the convergence of the focal points of the plurality of floating display modules. The reference coordinate point can serve as the projection coordinate point for stereoscopic images, ensuring that all stereoscopic image projections overlap along the same axis. Furthermore, the projection center points of the plurality of floating display modules also align with the same reference coordinate point. This ensures that the stereoscopic projection positions of the plurality of floating display modules align with a common origin and a common coordinate system, achieving an optimal wide-angle floating projection effect.

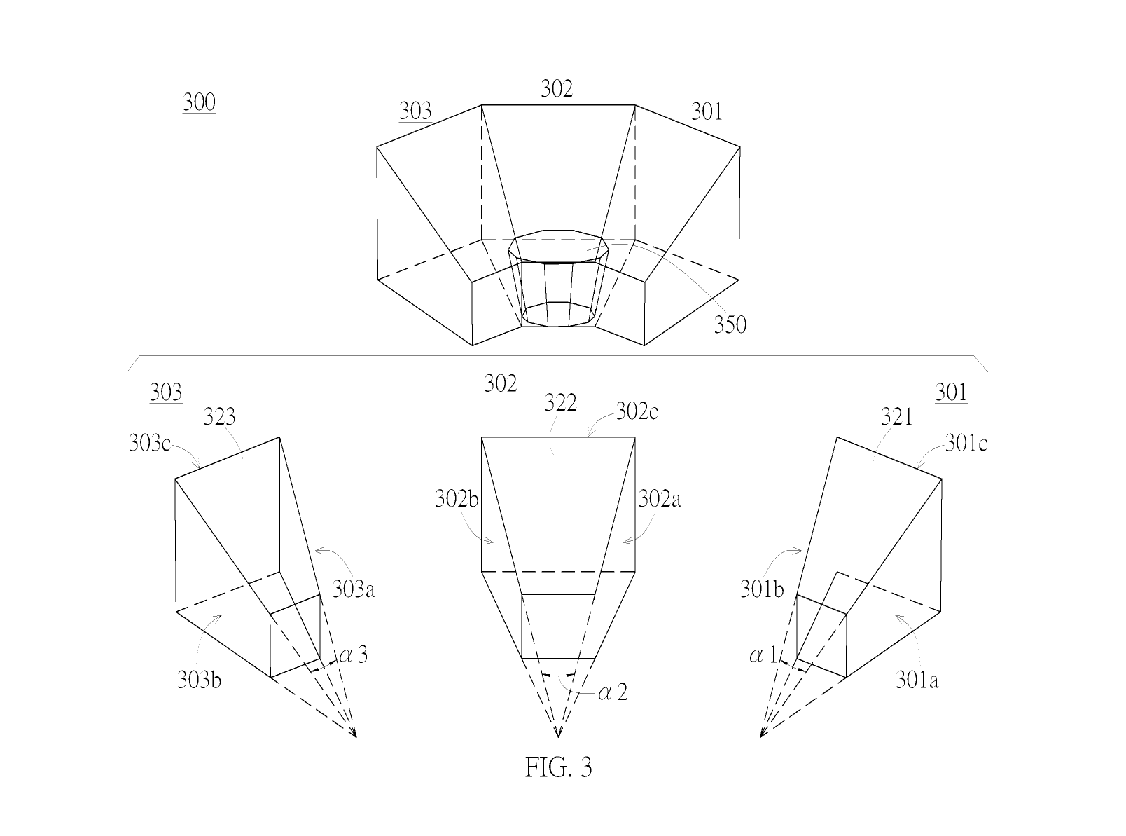

Referring to FIG. 3, a floating stereoscopic display device 300 is disclosed in one embodiment of the present invention, including a first floating display module 301, a second floating display module 302, and a third floating display module 303. The floating stereoscopic display device 300 may be substantially similar to the floating stereoscopic display device 100 shown in FIG. 1J and the floating stereoscopic display device 200 shown in FIG. 2A, where like reference numerals indicate like components. For the sake of brevity, detailed descriptions are omitted herein, and the previously described floating stereoscopic display device and its related details are applicable to the present embodiment.

In the embodiment shown in FIG. 3, the first floating display module 301 includes a first light field display (not shown) and a first reflective projection element 321, the second floating display module 302 includes a second light field display (not shown) and a second reflective projection element 322, and the third floating display module 303 includes a third light field display (not shown) and a third reflective projection element 323. The previously described floating display module, light field display, reflective projection element, and related details are applicable to the present embodiment. In some embodiments, for each of the plurality of floating display modules, a portion adjacent to the reflective projection element includes a light-absorbing material or an opaque material. Take the first floating display module 301 as an example, the portion adjacent to the reflective projection element 321 may include a first coupling surface 301a, a second coupling surface 301b, or a third coupling surface 301c, and at least one of these coupling surfaces may include a light-absorbing material or an opaque material. Light-absorbing material or opaque material may include black powder coatings, carbon-based materials such as carbon black, black rubber, or black acrylonitrile butadiene styrene (ABS). However, these materials are provided merely as examples and are not intended to be limiting; materials with appropriate characteristics may be selected as needed. As shown in FIG. 3, a portion of the first floating display module 301 adjacent to the first reflective projection element 321, a portion of the second floating display module 302 adjacent to the second reflective projection element 322, and a portion of the third floating display module 303 adjacent to the third reflective projection element 323, such as peripheral parts (including sides, bottom, back cover, etc., or the coupling surface referred to herein), may include a light-absorbing material or an opaque material to prevent crosstalk between the floating display modules.

In some embodiments, each of the plurality of floating display modules includes a first coupling surface and a second coupling surface, and the plurality of floating display modules are adjacently spliced to each other through the first coupling surfaces and the second coupling surfaces of the plurality of floating display modules. In the embodiment shown in FIG. 3, the first floating display module 301 includes a first coupling surface 301a, a second coupling surface 301b, and a third coupling surface 301c; the second floating display module 302 includes a first coupling surface 302a, a second coupling surface 302b, and a third coupling surface 302c; the third floating display module 303 includes a first coupling surface 303a, a second coupling surface 303b, and a third coupling surface 303c. The first floating display module 301 and the second floating display module 302 are adjacently spliced to each other through the first coupling surface 302a of the second floating display module 302 and the second coupling surface 301b of the first floating display module 301. The second floating display module 302 and the third floating display module 303 are adjacently spliced to each other through the first coupling surface 303a of the third floating display module 303 and the second coupling surface 302b of the second floating display module 302. However, the present invention is not limited thereto. The floating display modules of the present invention may employ different shapes, quantities, and assembly methods, enabling the plurality of floating display modules to function independently or be assembled into a floating stereoscopic display device, or providing various configurations as required. Furthermore, while ensuring tight assembly and providing sufficient stereoscopic display space and viewpoint continuity, the appearance of the floating display modules can be appropriately modified. This allows the overall shape of the floating stereoscopic display device assembled by the floating display modules to better align with the product requirements. It should be noted that the term “adjacent” as used herein refers to a tightly spliced configuration. This ensures sufficient overlap of the stereoscopic display space and continuity of the viewpoint, thereby providing a wide-angle floating projection effect.

In some embodiments, the first coupling surface and the second coupling surface correspondingly spliced to each other are completely overlapped. In the embodiment shown in FIG. 3, the first coupling surface 302a of the second floating display module 302 and the second coupling surface 301b of the first floating display module 301 are completely overlapped, and the first coupling surface 303a of the third floating display module 303 and the second coupling surface 302b of the second floating display module 302 are completely overlapped. This ensures sufficient overlap of the stereoscopic image and continuity of the viewpoint, thereby providing a wide-angle floating projection effect.

In some embodiments, each of the first coupling surfaces and the second coupling surfaces includes a light-absorbing material or an opaque material. Light-absorbing material or opaque material may include black powder coatings, carbon-based materials such as carbon black, black rubber, or black ABS. However, these materials are provided merely as examples and are not intended to be limiting; materials with appropriate characteristics may be selected as needed. For example, as shown in FIG. 3, the first coupling surfaces 301a, 302a, 303a, and the second coupling surfaces 301b, 302b, 303b include a light-absorbing material or an opaque material to prevent crosstalk between the floating display modules. In the embodiment shown in FIG. 3, the third coupling surfaces 301c, 302c, 303c or the bottom surfaces may also include a light-absorbing material or an opaque material.

In some embodiments, an included angle is formed between the first coupling surface and the second coupling surface, and the plurality of floating display modules are arranged adjacent to each other around the stereoscopic imaging space based on the included angles of the plurality of floating display modules. In the embodiment shown in FIG. 3, a first included angle α1 is formed between the first coupling surface 301a and the second coupling surface 301b of the first floating display module 301; a second included angle α2 is formed between the first coupling surface 302a and the second coupling surface 302b of the second floating display module 302; a third included angle α3 is formed between the first coupling surface 303a and the second coupling surface 303b of the third floating display module 303. The first floating display module 301, the second floating display module 302, and the third floating display module 303 are arranged adjacent to each other around the stereoscopic imaging space 350 based on the first included angle α1, the second included angle α2, and the third included angle α3. In some embodiments, these included angles are all equal. However, in other embodiments, the first coupling surfaces and second coupling surfaces of the plurality of floating display modules may form different included angles, enabling various configurations tailored to the projection requirements.

Referring to FIGS. 4A to 4E, a floating stereoscopic display device 400 is disclosed in one embodiment of the present invention, including a first floating display module 401, a second floating display module 402, and a third floating display module 403. The floating stereoscopic display device 400 may be substantially similar to the floating stereoscopic display device 100 shown in FIG. 1J, the floating stereoscopic display device 200 shown in FIG. 2A, and the floating stereoscopic display device 300 shown in FIG. 3, where like reference numerals indicate like components. For the sake of brevity, detailed descriptions are omitted herein, and the previously described floating stereoscopic display device and its related details are applicable to the present embodiment.

Referring to FIG. 4A, the first light field display 411 emits lights generated according to the stereoscopic image data provided by the first image processor (not shown) via a first light path I11 and a third light path I31. These lights are projected to the first stereoscopic display space through the first reflective projection element 421 to form a stereoscopic image (not shown). The number of light paths shown here is merely illustrative. Specifically, the first light path I11 represents the leftmost light beam projectable by the first floating display module 401, and the third light path I31 represents the rightmost light beam projectable by the first floating display module 401. The region defined by the intersection of the two light paths in front of the first floating display module 401 provides a first viewpoint region 481, and the angle between the first light path I11 and the third light path I31 constitutes a first emergence angle θ1 of the first floating display module 401. The previously described floating display module, light field display, reflective projection element, and their related details are applicable to the present embodiment. For illustrative purposes, the first viewpoint region 481 in FIG. 4A is represented by a schematic triangle. However, those skilled in the art will recognize that the viewpoint region of the floating display module constitutes a stereoscopic space extending at least to the depth of field in front of the floating display module.

Referring to FIG. 4B, the second light field display 412 emits lights generated according to the stereoscopic image data provided by the second image processor (not shown) via a first light path I12 and a third light path I32. These lights are projected to the second stereoscopic display space through the second reflective projection element 422 to form a stereoscopic image (not shown). The number of light paths shown here is merely illustrative. Specifically, the first light path I12 represents the leftmost light beam projectable by the second floating display module 402, and the third light path I32 represents the rightmost light beam projectable by the second floating display module 402. The region defined by the intersection of the two light paths in front of the second floating display module 402 provides a second viewpoint region 482, and the angle between the first light path I12 and the third light path I32 constitutes a second emergence angle θ2 of the second floating display module 402. The previously described floating display module, light field display, reflective projection element, and their related details are applicable to the present embodiment. For illustrative purposes, the second viewpoint region 482 in FIG. 4B is represented by a schematic triangle. However, those skilled in the art will recognize that the viewpoint region of the floating display module constitutes a stereoscopic space extending at least to the depth of field in front of the floating display module.

Referring to FIG. 4C, the third light field display 413 emits lights generated according to the stereoscopic image data provided by the third image processor (not shown) via a first light path I13 and a third light path I33. These lights are projected to the third stereoscopic display space through the third reflective projection element 423 to form a stereoscopic image (not shown). The number of light paths shown here is merely illustrative. Specifically, the first light path I13 represents the leftmost light beam projectable by the third floating display module 403, and the third light path I33 represents the rightmost light beam projectable by the third floating display module 403. The region defined by the intersection of the two light paths in front of the third floating display module 403 provides a third viewpoint region 483, and the angle between the first light path I13 and the third light path I33 constitutes a third emergence angle θ3 of the third floating display module 403. The previously described floating display module, light field display, reflective projection element, and their related details are applicable to the present embodiment. For illustrative purposes, the third viewpoint region 483 in FIG. 4C is represented by a schematic triangle. However, those skilled in the art will recognize that the viewpoint region of the floating display module constitutes a stereoscopic space extending at least to the depth of field in front of the floating display module.

In some embodiments, each of the plurality of floating display modules has an emergence angle to provide a viewpoint region, and the viewpoint regions of the plurality of floating display modules are at least partially overlapped to form a continuous viewpoint region. Referring to FIGS. 4A to 4E, the first floating display module 401 has the first emergence angle θ1 to provide the first viewpoint region 481, the second floating display module 402 has the second emergence angle θ2 to provide the second viewpoint region 482, and the third floating display module 403 has the third emergence angle θ3 to provide the third viewpoint region 483. The first viewpoint region 481, the second viewpoint region 482, and the third viewpoint region 483 are at least partially overlapped to form a continuous viewpoint region 480. In some embodiments, these emergence angles are all equal. However, in other embodiments, the emergence angles of the plurality of floating display modules may be different, enabling different configurations according to the projection requirements. For illustrative purposes, the continuous viewpoint region 480 shown in FIGS. 4D and 4E is merely illustrated as the overlapping portion in the stereoscopic imaging space 450. However, those skilled in the art will recognize that the continuous viewpoint region of the floating display module constitutes a stereoscopic space extending at least to the depth of field in front of the floating display module.

As shown in FIG. 4E, the first viewpoint V1 is located within the stereoscopic imaging space 450 and the continuous viewpoint region 480. When viewed from left to right, images are sequentially provided by the first floating display module 401, the second floating display module 402, and the third floating display module 403. This eliminates viewpoint discontinuity and simultaneously expands the range of the viewing angle. Conversely, as shown in FIG. 4E, the second viewpoint V2 is located within the stereoscopic imaging space 450 but falls outside the continuous viewpoint region 480. When viewed from left to right, images are sequentially provided by the first floating display module 401, the second floating display module 402, and the third floating display module 403. However, constrained by the limitations of the emergence angles, transitions from the first floating display module 401 to the second floating display module 402, and from the second floating display module 402 to the third floating display module 403, all exhibit viewpoint discontinuity because the second viewpoint V2 lies outside each viewpoint region.

In some embodiments, an included angle is formed between the first coupling surface and the second coupling surface, and for each of the plurality of floating display modules, the included angle is smaller than the emergence angle. In the embodiment shown in FIGS. 4A to 4E, a first included angle α1 is formed between the first coupling surface 401a and the second coupling surface 401b of the first floating display module 401; a second included angle α2 is formed between the first coupling surface 402a and the second coupling surface 402b of the second floating display module 402; a third included angle α3 is formed between the first coupling surface 403a and the second coupling surface 403b of the third floating display module 403. The first included angle α1 is smaller than the first emergence angle θ1, the second included angle α2 is smaller than the second emergence angle θ2, and the third included angle α3 is smaller than the third emergence angle θ3. The previously described included angle, emergence angle, and related details are applicable to the present embodiment.

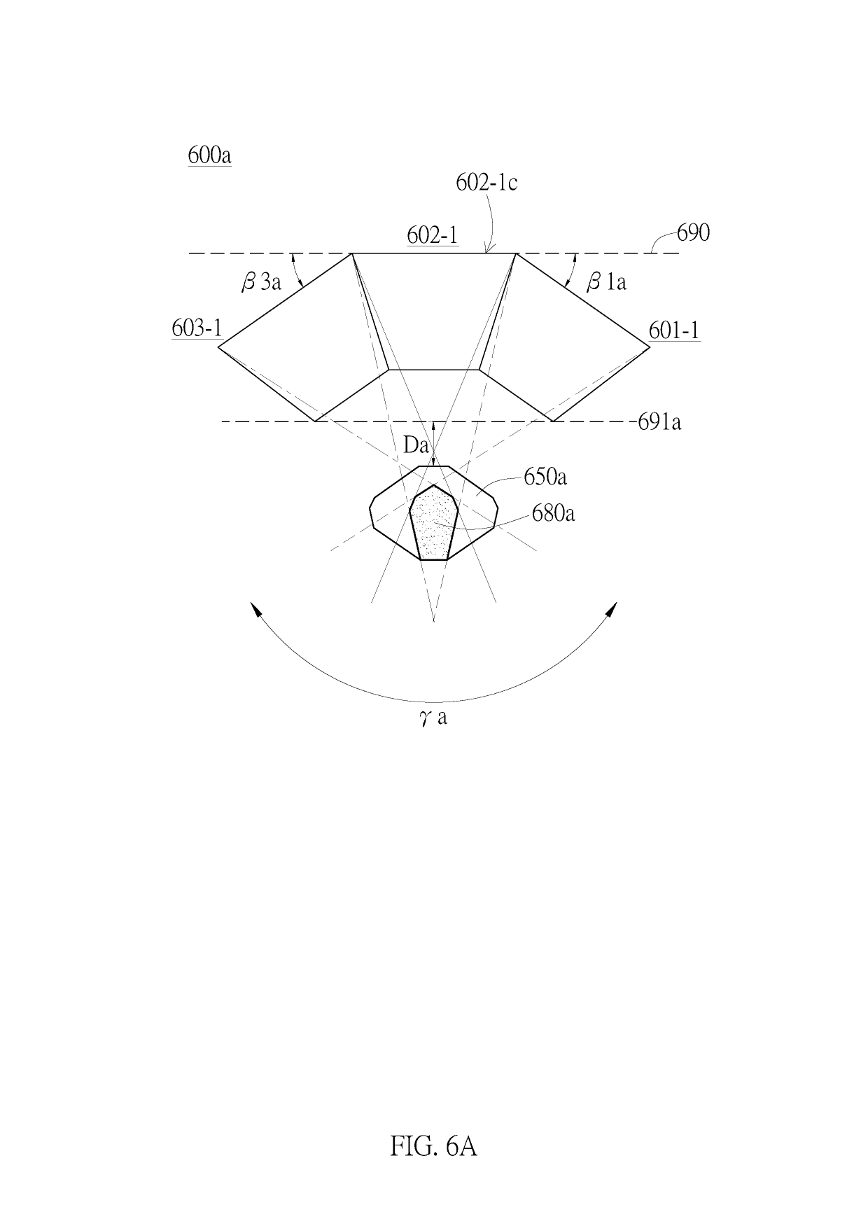

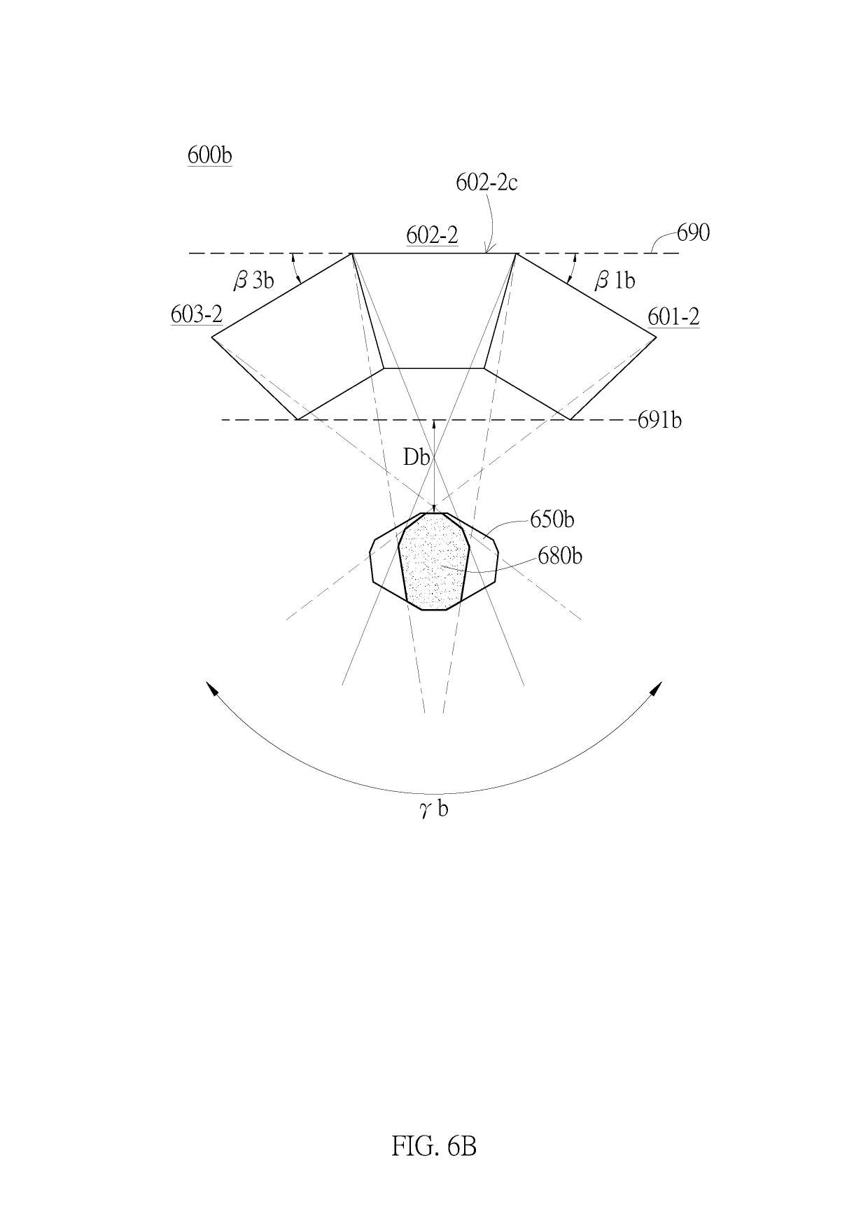

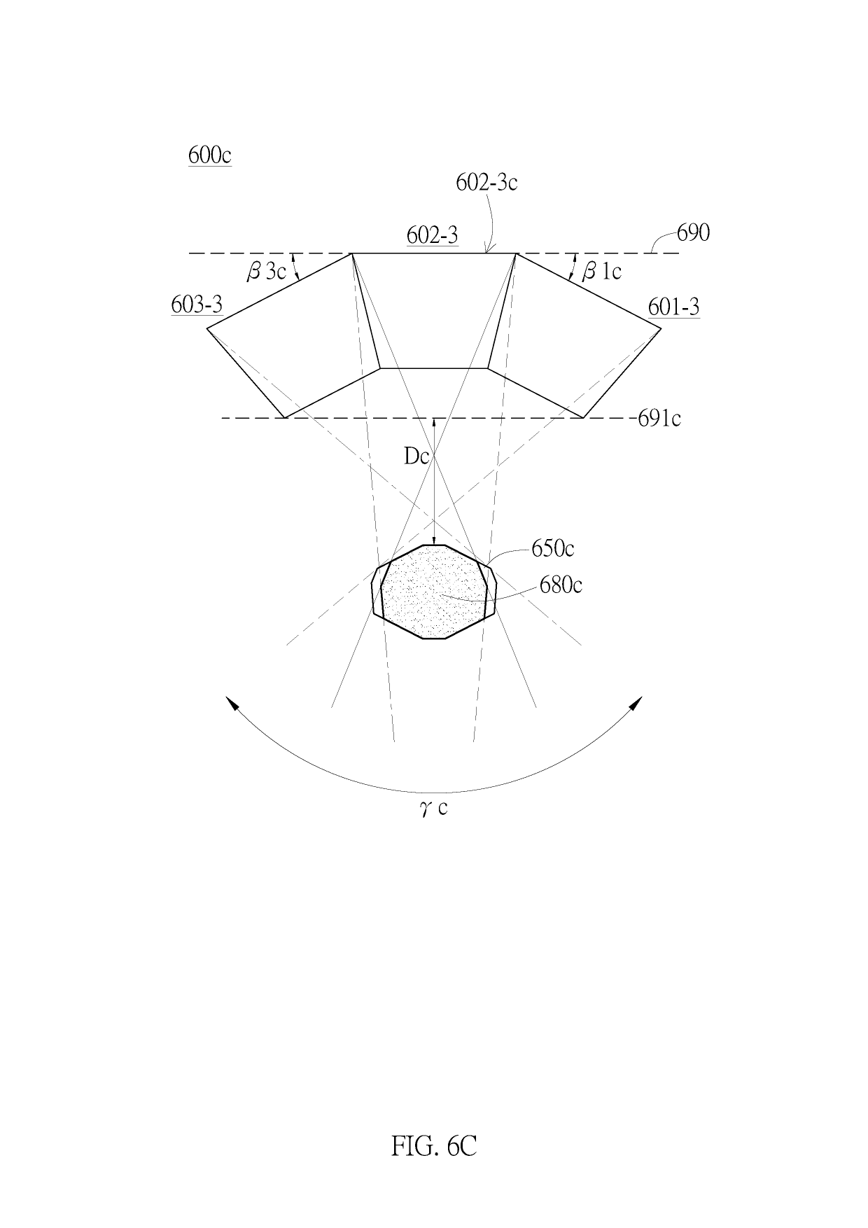

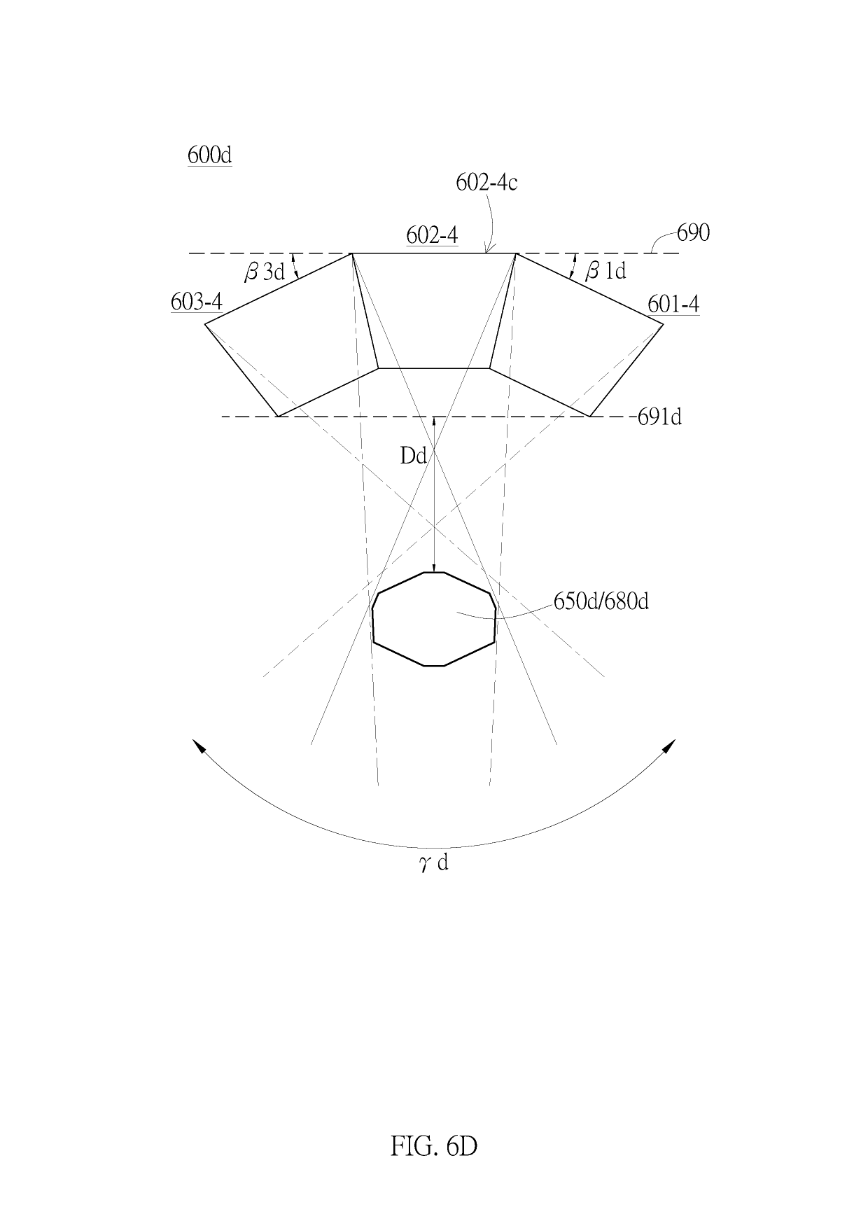

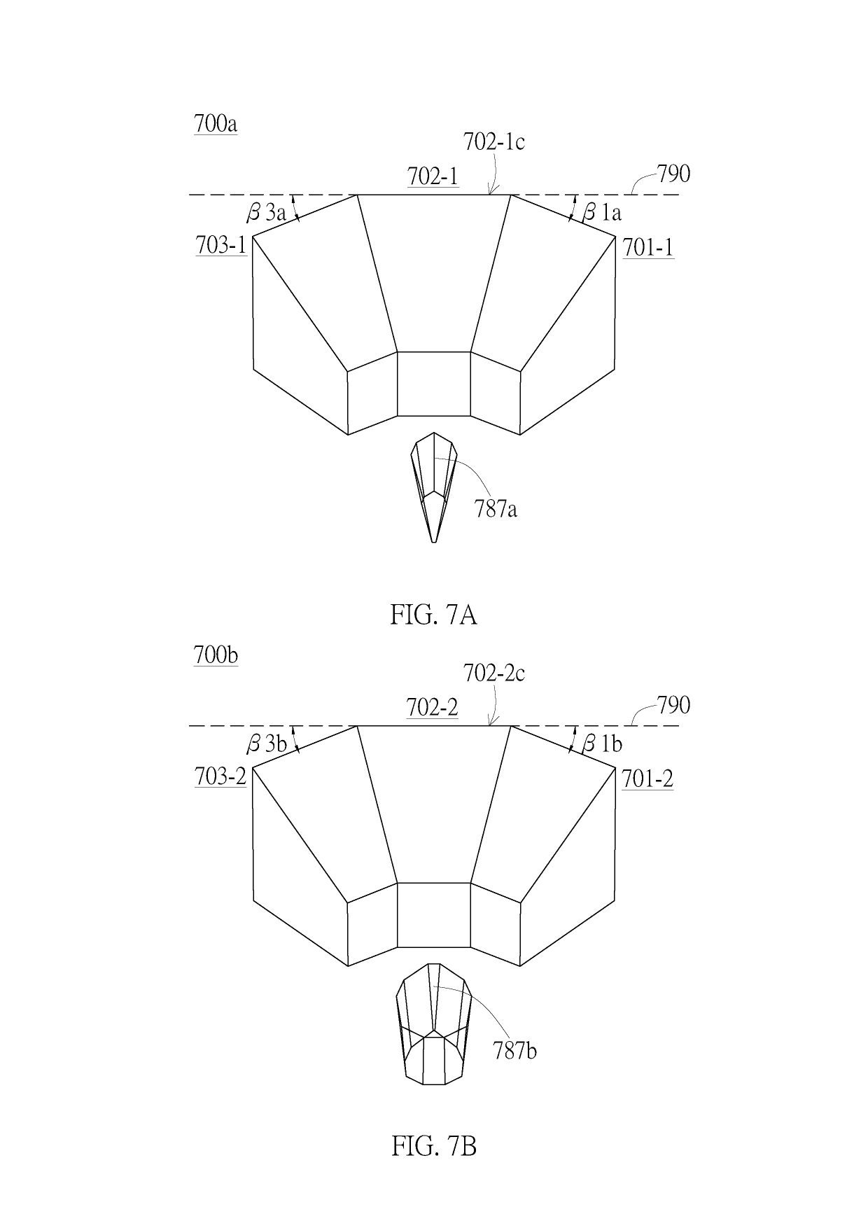

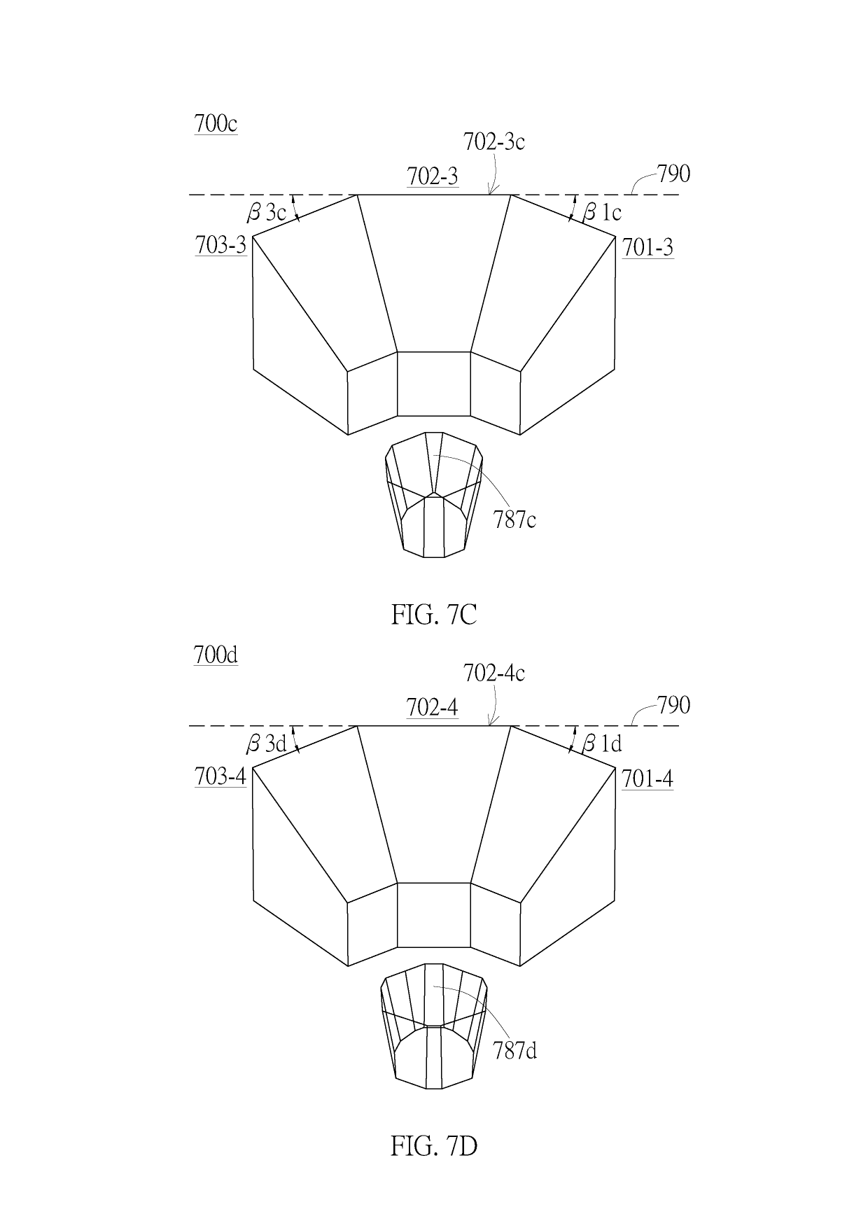

In the embodiment shown in FIGS. 4D to 4E, the first floating display module 401 and the third floating display module 403 respectively form a first angle β1 and a third angle β3 with a reference plane 490, and the continuous viewpoint region 480 at least partially overlaps with the stereoscopic imaging space 450, where a third coupling surface 402c of the second floating display module 402 is coincident with the reference plane 490. Specifically, the first angle β1 between the first floating display module 401 and the reference plane 490 may be the angle formed between the third coupling surface 401c of the first floating display module 401 and the reference plane 490. The third angle β3 between the third floating display module 403 and the reference plane 490 may be the angle formed between the third coupling surface 403c of the third floating display module 403 and the reference plane 490. The angles between the floating display modules and the reference plane will be described in detail in the embodiments shown in FIGS. 6A to 6D and FIGS. 7A to 7D.

When the angle between the floating display module and the reference plane is smaller than the emergence angle, the continuous viewpoint region and the stereoscopic imaging space can have a larger overlapping range, providing a better projection effect. When the angle between the floating display module and the reference plane is equal to or greater than the emergence angle, the continuous viewpoint region becomes too small or even disappears, easily causing discontinuity in the viewpoints and weakening the wide-angle floating projection effect. In some embodiments, the angle between each floating display module and the reference plane is smaller than the respective emergence angle. In the embodiments shown in FIGS. 4A to 4E, the first angle β1 is smaller than the first emergence angle θ1, and the third angle β3 is smaller than the third emergence angle θ3. In the embodiments shown in FIGS. 4A to 4E, the first angle β1 and the third angle β3 are between 25 degrees and 35 degrees, and the first emergence angle θ1, the second emergence angle θ2, and the third emergence angle θ3 are between 40 degrees and 45 degrees. However, these values are provided merely as examples and are not intended to be limiting. The angle between the floating display module and the reference plane, as well as the emergence angle, may be modified according to the projection requirements. In some embodiments, the emergence angle of the floating display module is determined by the reflective projection element. For example, when the reflective projection element is a DCRA with a reflective layer thickness of 1.5 mm, its emergence angle is approximately 40 degrees (±20 degrees). When the reflective projection element is a DCRA with a reflective layer thickness of 1.25 mm, the emergence angle is approximately 50 degrees (±25 degrees). Although thinner reflective layers may offer wider emergence angles, manufacturing constraints inherent to the DCRA process limit their feasibility. The present invention overcomes these limitations, enabling wide-viewing-angle floating stereoscopic images and expanding the technology’s application scope.

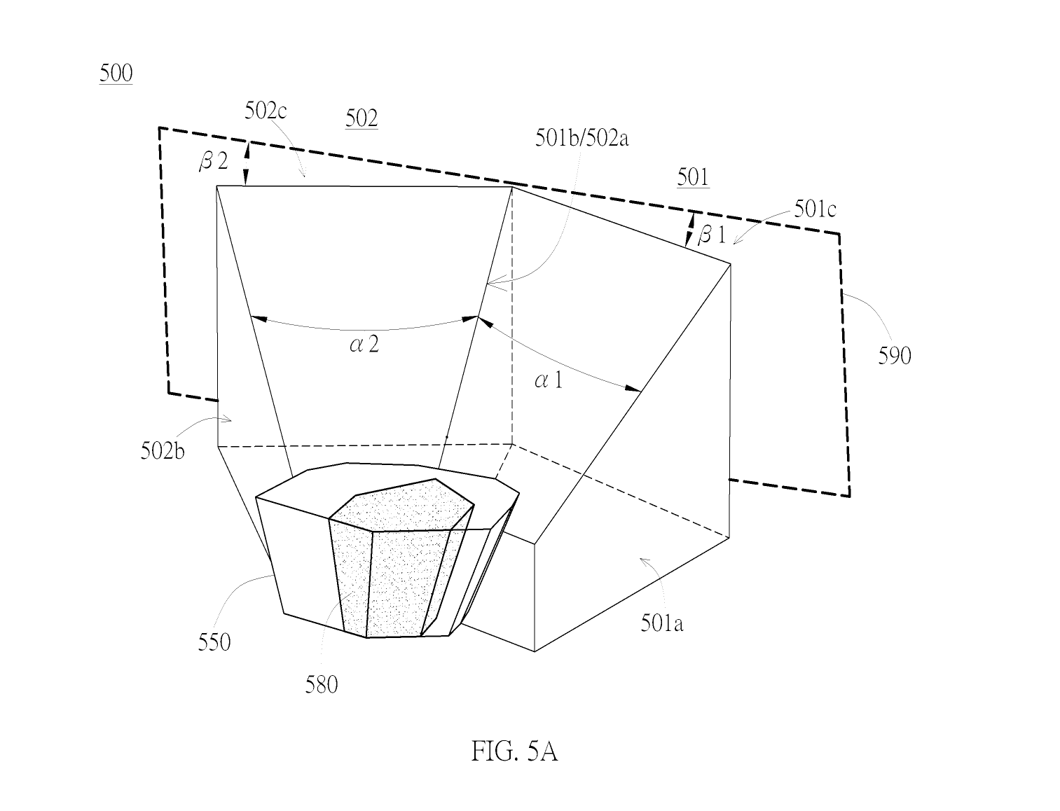

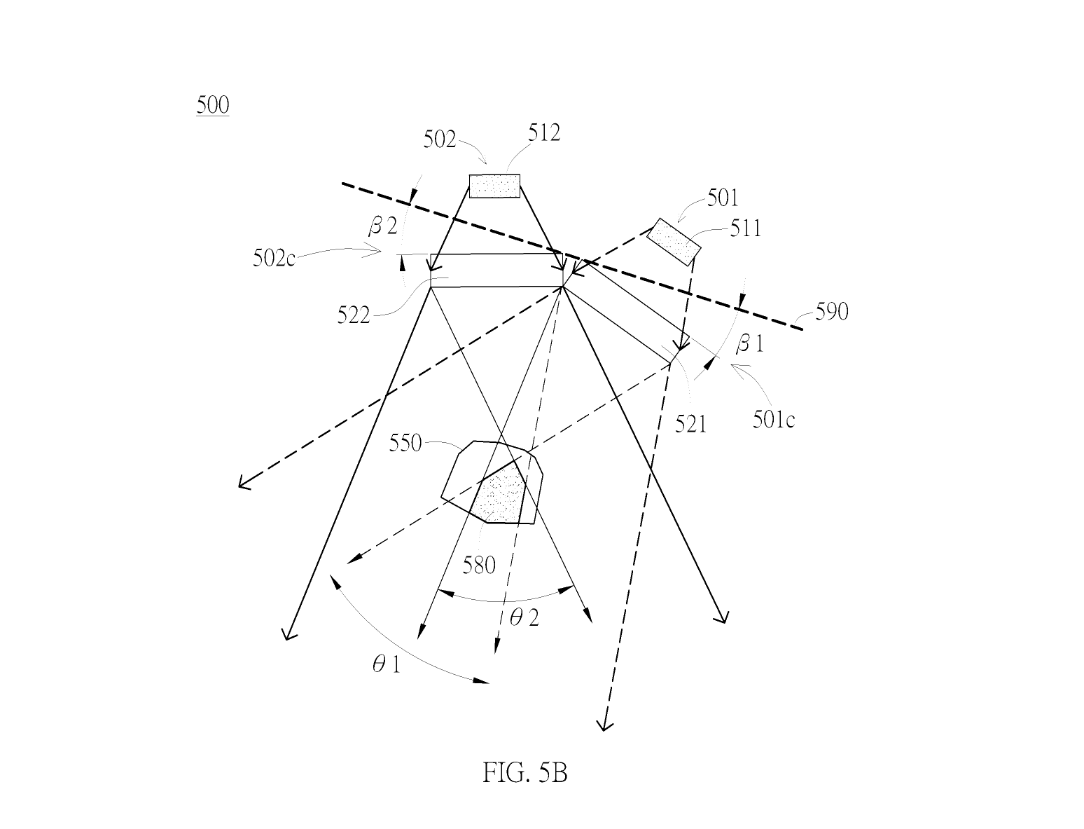

Referring to FIGS. 5A to 5B, a floating stereoscopic display device 500 is disclosed in one embodiment of the present invention, including a first floating display module 501 and a second floating display module 502. The floating stereoscopic display device 500 may be substantially similar to the floating stereoscopic display device 400 shown in FIGS. 4D to 4E, where like reference numerals indicate like components. For the sake of brevity, detailed descriptions are omitted herein, and the previously described floating stereoscopic display device and its related details are applicable to the present embodiment.

In the embodiment shown in FIGS. 5A to 5B, the first light field display 511 emits lights generated according to the stereoscopic image data provided by the first image processor (not shown). These lights are projected to the first stereoscopic display space through the first reflective projection element 521 to form a stereoscopic image (not shown). The second light field display 512 emits lights generated according to the stereoscopic image data provided by the second image processor (not shown). These lights are projected to the second stereoscopic display space through the second reflective projection element 522 to form a stereoscopic image (not shown). The previously described floating display module, light field display, reflective projection element, and their related details are applicable to the present embodiment.

In the embodiment shown in FIGS. 5A to 5B, the first floating display module 501 has a first emergence angle θ1 to provide the first viewpoint region (not shown), the second floating display module 502 has a second emergence angle θ2 to provide the second viewpoint region (not shown). The first viewpoint region and the second viewpoint region are at least partially overlapped to form a continuous viewpoint region 580. For illustrative purposes, the continuous viewpoint region 580 shown in FIGS. 5A and 5B is merely illustrated as the overlapping portion in the stereoscopic imaging space 550. However, those skilled in the art will recognize that the continuous viewpoint region of the floating display module constitutes a stereoscopic space extending at least to the depth of field in front of the floating display module. The previously described emergence angle, viewpoint region, and their related details are applicable to the present embodiment.

In some embodiments, an included angle is formed between the first coupling surface and the second coupling surface, and for each of the plurality of floating display modules, the included angle is smaller than the emergence angle. In the embodiment shown in FIGS. 5A to 5B, a first included angle α1 is formed between the first coupling surface 501a and the second coupling surface 501b of the first floating display module 501; a second included angle α2 is formed between the first coupling surface 502a and the second coupling surface 502b of the second floating display module 502. The first included angle α1 is smaller than the first emergence angle θ1, and the second included angle α2 is smaller than the second emergence angle θ2. The previously described included angle, emergence angle, and related details are applicable to the present embodiment.

In the embodiment shown in FIGS. 5A to 5B, the first floating display module 501 and the second floating display module 502 respectively form a first angle β1 and a second angle β2 with a reference plane 590, and the continuous viewpoint region 580 at least partially overlaps with the stereoscopic imaging space 550. The reference plane 590 may be perpendicular to the first coupling surface 502a or the second coupling surface 501b. Specifically, the first angle β1 between the first floating display module 501 and the reference plane 590 may be the angle formed between the third coupling surface 501c of the first floating display module 501 and the reference plane 590. The second angle β2 between the second floating display module 502 and the reference plane 590 may be the angle formed between the third coupling surface 502c of the second floating display module 502 and the reference plane 590.

In some embodiments, the angle between each floating display module and the reference plane is smaller than the respective emergence angle. In the embodiments shown in FIGS. 5A to 5B, the first angle β1 is smaller than the first emergence angle θ1, and the second angle β2 is smaller than the second emergence angle θ2. In the embodiments shown in FIGS. 5A to 5B, the first angle β1 and the second angle β2 are between 12.5 degrees and 17.5 degrees, and the first emergence angle θ1 and the second emergence angle θ2 are between 40 degrees and 45 degrees. However, these values are provided merely as examples and are not intended to be limiting. The angle between the floating display module and the reference plane, as well as the emergence angle, may be modified according to the projection requirements.

Referring to FIGS. 6A to 6D, four floating stereoscopic display devices 600a, 600b, 600c, and 600d are provided in different embodiments of the present invention, respectively including a first floating display module 601-1, 601-2, 601-3, 601-4, a second floating display module 602-1, 602-2, 602-3, 602-4, and a third floating display module 603-1, 603-2, 603-3, 603-4. The floating stereoscopic display devices 600a to 600d may be substantially similar to the floating stereoscopic display device 400 shown in FIGS. 4D to 4E, where like reference numerals indicate like components. For the sake of brevity, detailed descriptions are omitted herein, and the previously described floating stereoscopic display device and its related details are applicable to the present embodiment.

In the embodiment shown in FIG. 6A, the first floating display module 601-1, the second floating display module 602-1, and the third floating display module 603-1 have the same emergence angle of 45 degrees. However, these values are provided merely as examples and are not intended to be limiting; the emergence angles of the floating display modules may be modified according to the projection requirements. The first floating display module 601-1 and the third floating display module 603-1 respectively form a first angle β1a and a third angle β3a with a reference plane 690, and the continuous viewpoint region 680a at least partially overlaps with the stereoscopic imaging space 650a. A third coupling surface 602-1c of the second floating display module 602-1 is coincident with the reference plane 690. In the embodiment shown in FIG. 6A, the first angle β1a and the third angle β3a are both 35 degrees. However, these values are provided merely as examples and are not intended to be limiting; the respective angles between the floating display modules and the reference plane may be modified according to the projection requirements.

In the embodiment shown in FIG. 6A, the stereoscopic imaging space 650a of the floating stereoscopic display device 600a is formed at a distance Da in front of the second floating display module 602-1. Specifically, the distance Da may be between the stereoscopic imaging space 650a and an extending plane 691a between the foremost portions of the first floating display module 601-1 and the third floating display module 603-1. However, the present invention is not limited thereto. The distance may be between the stereoscopic imaging space and an imaginary plane formed by the foremost portions of the outermost floating display modules. The floating stereoscopic display device 600a possesses a total viewing angle γa, which is the maximum angle between the light paths projected by the plurality of floating display modules, typically formed by the outermost light paths. For example, as shown in FIG. 6A, the total viewing angle γa is the angle between the leftmost light path projected by the first floating display module 601-1 and the rightmost light path projected by the third floating display module 603-1. When the emergence angle is 45 degrees and the first angle β1a and the third angle β3a are 35 degrees, the total viewing angle γa is 115 degrees. However, these values are provided merely as examples and are not intended to be limiting. As previously described, the angle between the floating display module and the reference plane, as well as the emergence angle, may be modified according to the projection requirements to achieve the desired total viewing angle.

In the embodiment shown in FIG. 6B, the first floating display module 601-2, the second floating display module 602-2, and the third floating display module 603-2 have the same emergence angle of 45 degrees. However, these values are provided merely as examples and are not intended to be limiting. The emergence angles of the floating display modules may be modified according to the projection requirements. The first floating display module 601-2 and the third floating display module 603-2 respectively form a first angle β1b and a third angle β3b with a reference plane 690, and the continuous viewpoint area 680b at least partially overlaps with the stereoscopic imaging space 650b. A third coupling surface 602-2c of the second floating display module 602-2 is coincident with the reference plane 690. In the embodiment shown in FIG. 6B, the first angle β1b and the third angle β3b are both 30 degrees. However, these values are provided merely as examples and are not intended to be limiting; the respective angles between the floating display modules and the reference plane may be modified according to the projection requirements.

In the embodiment shown in FIG. 6B, the stereoscopic imaging space 650b of the floating stereoscopic display device 600b is formed at a distance Db in front of the second floating display module 602-2. Specifically, the distance Db may be between the stereoscopic imaging space 650b and an extending plane 691b between the foremost portions of the first floating display module 601-2 and the third floating display module 603-2. However, the present invention is not limited thereto. The distance may be between the stereoscopic imaging space and an imaginary plane formed by the foremost portions of the outermost floating display modules. The floating stereoscopic display device 600b possesses a total viewing angle γb, which is the maximum angle between the light paths projected by each of the plurality of floating display modules, typically defined by the outermost light paths. For example, as shown in FIG. 6B, the total viewing angle γb is the angle between the leftmost light path projected by the first floating display module 601-2 and the rightmost light path projected by the third floating display module 603-2. When the emergence angle is 45 degree and the first angle β1b and third angle β3b are 30 degrees, the total viewing angle γb is 105 degrees. However, these values are provided merely as examples and are not intended to be limiting. As previously described, the angle between the floating display module and the reference plane, as well as the emergence angle, may be modified according to the projection requirements to achieve the desired total viewing angle.

In the embodiment shown in FIG. 6C, the first floating display module 601-3, the second floating display module 602-3, and the third floating display module 603-3 have the same emergence angle of 45 degrees. However, these values are provided merely as examples and are not intended to be limiting. The emergence angles of the floating display modules may be modified according to the projection requirements. The first floating display module 601-3 and the third floating display module 603-3 respectively form a first angle β1c and a third angle β3c with a reference plane 690, and the continuous viewpoint area 680c at least partially overlaps with the stereoscopic imaging space 650c. A third coupling surface 602-3c of the second floating display module 602-3 is coincident with the reference plane 690. In the embodiment shown in FIG. 6C, the first angle β1c and the third angle β3c are both 27 degrees. However, these values are provided merely as examples and are not intended to be limiting; the respective angles between the floating display modules and the reference plane may be modified according to the projection requirements.

In the embodiment shown in FIG. 6C, the stereoscopic imaging space 650c of the floating stereoscopic display device 600c is formed at a distance Dc in front of the second floating display module 602-3. Specifically, the distance Dc may be between the stereoscopic imaging space 650c and an extending plane 691c between the foremost portions of the first floating display module 601-3 and the third floating display module 603-3. However, the present invention is not limited thereto. The distance may be between the stereoscopic imaging space and an imaginary plane formed by the foremost portions of the outermost floating display modules. The floating stereoscopic display device 600c possesses a total viewing angle γc, which is the maximum angle between the light paths projected by the plurality of floating display modules, typically defined by the outermost light paths. For example, as shown in FIG. 6C, the total viewing angle γc is the angle between the leftmost light path projected by the first floating display module 601-3 and the rightmost light path projected by the third floating display module 603-3. When the emergence angle is 45 degrees and the first angle β1c and third angle β3c are 27 degrees, the total viewing angle γc is 99 degrees. However, these values are provided merely as examples and are not intended to be limiting. As previously described, the angle between the floating display module and the reference plane, as well as the emergence angle, may be modified according to the projection requirements to achieve the desired total viewing angle.

In the embodiment shown in FIG. 6D, the first floating display module 601-4, the second floating display module 602-4, and the third floating display module 603-4 have the same emergence angle of 45 degrees. However, these values are provided merely as examples and are not intended to be limiting. The emergence angles of the floating display modules may be modified according to the projection requirements. The first floating display module 601-4 and the third floating display module 603-4 respectively form a first angle β1d and a third angle β3d with a reference plane 690, and the continuous viewpoint area 680d at least partially overlaps with the stereoscopic imaging space 650d. A third coupling surface 602-4c of the second floating display module 602-4 is coincident with the reference plane 690. In the embodiment shown in FIG. 6D, the first angle β1d and the third angle β3d are both 25 degrees. However, these values are provided merely as examples and are not intended to be limiting; the respective angles between the floating display modules and the reference plane may be modified according to the projection requirements.

In the embodiment shown in FIG. 6D, the stereoscopic imaging space 650d of the floating stereoscopic display device 600d is formed at a distance Dd in front of the second floating display module 602-4. Specifically, the distance Dd may be between the stereoscopic imaging space 650d and an extending plane 691d between the foremost portions of the first floating display module 601-4 and the third floating display module 603-4. However, the present invention is not limited thereto. The distance may be between the stereoscopic imaging space and an imaginary plane formed by the foremost portions of the outermost floating display modules. The floating stereoscopic display device 600d possesses a total viewing angle γd, which is the maximum angle between the light paths projected by the plurality of floating display modules, typically defined by the outermost light paths. For example, as shown in FIG. 6D, the total viewing angle γd is the angle between the leftmost light path projected by the first floating display module 601-4 and the rightmost light path projected by the third floating display module 603-4. When the emergence angle is 45 degrees and the first angle β1d and third angle β3d are 25 degrees, the total viewing angle γd is 95 degrees. However, these values are provided merely as examples and are not intended to be limiting. As previously described, the angle between the floating display module and the reference plane, as well as the emergence angle, may be modified according to the projection requirements to achieve the desired total viewing angle.

For illustrative purposes, the continuous viewpoint regions 680a to 680d shown in FIGS. 6A to 6D are merely illustrated as the overlapping portion in the respective stereoscopic imaging space 650a to 650d. However, those skilled in the art will recognize that the continuous viewpoint region of the floating display module constitutes a stereoscopic space extending at least to the depth of field in front of the floating display module.

The total viewing angle of the floating stereoscopic display device is related to the emergence angle of the floating display module and the angle between the floating display module and the reference plane. Under the condition of identical emergence angle, a smaller angle between the floating display module and the reference plane results in a smaller total viewing angle. Specifically, the total viewing angle is calculated as the sum of the angles between the outermost floating display modules and the reference plane, plus the average of the emergence angles of the outermost floating display modules. For example, as shown in FIG. 6A, the sum of the angles between the outermost floating display modules 601-1, 603-1 and the reference plane 690 is β1a+β3a, which equals 70 degrees. By adding the average emergence angle of the outermost floating display modules 601-1, 603-1, which is 45 degrees, a total viewing angle γa of 115 degrees is calculated. As shown in FIG. 6B, the sum of the angles between the outermost floating display modules 601-2 and 603-2 and the reference plane 690 is β1b+β3b, which equals 60 degrees. By adding the average emergence angle of the outermost floating display modules 601-2, 603-2, which is 45 degrees, a total viewing angle γb of 105 degrees is calculated. As shown in FIG. 6C, the sum of the angles between the outermost floating display modules 601-3 and 603-3 and the reference plane 690 is β1c+β3c, which equals 54 degrees. By adding the average emergence angle of the outermost floating display modules 601-3, 603-3, which is 45 degrees, a total viewing angle γc of 99 degrees is calculated. As shown in FIG. 6D, the sum of the angles between the outermost floating display modules 601-4 and 603-4 and the reference plane 690 is β1d+β3d, which equals 50 degrees. By adding the average emergence angle of the outermost floating display modules 601-4, 603-4, which is 45 degrees, a total viewing angle γd of 95 degrees is calculated. These values are provided as examples and are not intended to be limiting. Accordingly, as shown in FIGS. 6A to 6D, as the first angle and the third angle decrease (from 35 degrees for β1a/β3a to 25 degrees for β1d/β3d), the total viewing angle decreases from 115 degrees for γa to 95 degrees for γd.

The size of the stereoscopic imaging space in a floating stereoscopic display device is related to the size of the floating display module, the emergence angle, and the angle between the floating display module and the reference plane. With the same emergence angle, the smaller the angle between the floating display module and the reference plane, the larger the stereoscopic imaging space. For example, as shown in FIG. 6A, when the light field display (not shown) of each floating display module is 7.9 inches, a reflective projection element (not shown) with a long side length of 20 cm, an emergence angle of 45 degrees, and the first angle β1a and the third angle β3a both at 35 degrees, the top surface area of the stereoscopic imaging space 650a is 12,643 mm². As shown in FIG. 6B, when the light field display (not shown) of each floating display module is 7.9 inches, a reflective projection element (not shown) with a long side length of 20 cm, an emergence angle of 45 degrees, and the first angle β1b and the third angle β3b both at 30 degrees, the top surface area of the stereoscopic imaging space 650b is 12,892 mm². As shown in FIG. 6C, when the light field display (not shown) of each floating display module is 7.9 inches, a reflective projection element (not shown) with a long side length of 20 cm, an emergence angle of 45 degrees, and the first angle β1c and the third angle β3c both at 27 degrees, the top surface area of the stereoscopic imaging space 650c is 13,221 mm². As shown in FIG. 6D, when the light field display (not shown) of each floating display module is 7.9 inches, a reflective projection element (not shown) with a long side length of 20 cm, an emergence angle of 45 degrees, and the first angle β1d and the third angle β3d both at 25 degrees, the top surface area of the stereoscopic imaging space 650d is 13,400 mm². These values are provided as examples and are not intended to be limiting. Accordingly, as shown in FIGS. 6A to 6D, as the first and third angles decrease (from 35 degrees for β1a/β3a to 25 degrees for β1d/β3d), the size of the stereoscopic imaging space increases (e.g., stereoscopic imaging spaces 650a to 650d).

The size of the continuous viewpoint region in a floating stereoscopic display device is related to the size of the floating display module, the emergence angle, and the angle between the floating display module and the reference plane. With the same emergence angle, the smaller the angle between the floating display module and the reference plane, the larger the continuous viewpoint region. For example, as shown in FIGS. 6A to 6D, as the first and third angles decrease (from 35 degrees for β1a/β3a to 25 degrees for β1d/β3d), the size of the continuous viewpoint regions increases (e.g., continuous viewpoint regions 680a to 680d).

The overlapping range of the continuous viewpoint region and the stereoscopic imaging space in a floating stereoscopic display device is related to the size of the floating display module, the emergence angle, and the angle between the floating display module and the reference plane. With the same emergence angle, the smaller the angle between the floating display module and the reference plane, the larger the overlapping range of the continuous viewpoint region and the stereoscopic imaging space. For example, as shown in FIGS. 6A to 6D, as the first and third angles decrease (from 35 degrees for β1a/β3a to 25 degrees for β1d/β3d), the overlapping range of the continuous viewpoint region and the stereoscopic imaging space increases.

The distance between the stereoscopic imaging space and the floating display module in a floating stereoscopic display device is related to the size of the floating display module, the emergence angle, and the angle between the floating display module and the reference plane. With the same emergence angle, the smaller the angle between the floating display module and the reference plane, the larger the distance between the stereoscopic imaging space and the floating display module. For example, as shown in FIGS. 6A to 6D, as the first and third angles decrease (from 35 degrees for β1a/β3a to 25 degrees for β1d/β3d), the distance between the stereoscopic imaging space and the floating display module increases (increases from Da to Dd). Accordingly, the floating stereoscopic display device provided by the present invention can simultaneously deliver long-distance, wide-angle floating projection effects, overcoming the limitations of existing technologies.

Referring to FIGS. 7A to 7D, four floating stereoscopic display devices 700a, 700b, 700c, and 700d are disclosed in one embodiment of the present invention, respectively including a first floating display module 701-1, 701-2, 701-3, 701-4, a second floating display module 702-1, 702-2, 702-3, 702-4, and a third floating display module 703-1, 703-2, 703-3, 703-4. The floating stereoscopic display devices 700a to 700d may be substantially similar to the floating stereoscopic display device 600a to 600d shown in FIGS. 6A to 6D, where like reference numerals indicate like components. For the sake of brevity, detailed descriptions are omitted herein, and the previously described floating stereoscopic display device and its related details are applicable to the present embodiment.

In the embodiment shown in FIG. 7A, the first floating display module 701-1, the second floating display module 702-1, and the third floating display module 703-1 have the same emergence angle of 45 degrees. However, these values are provided merely as examples and are not intended to be limiting; the emergence angles of the floating display modules may be modified according to the projection requirements. The first floating display module 701-1 and the third floating display module 703-1 respectively form a first angle β1a and a third angle β3a with a reference plane 790, and the continuous viewpoint region at least partially overlaps with the stereoscopic imaging space. A third coupling surface 702-1c of the second floating display module 702-1 is coincident with the reference plane 790. The continuous viewpoint region and the stereoscopic imaging space are combined (overlapped) to form a continuous viewpoint stereoscopic imaging space 787a. In the embodiment shown in FIG. 7A, the first angle β1a and the third angle β3a are both 35 degrees. However, these values are provided merely as examples and are not intended to be limiting; the respective angles between the floating display modules and the reference plane may be modified according to the projection requirements.

In the embodiment shown in FIG. 7B, the first floating display module 701-2, the second floating display module 702-2, and the third floating display module 703-2 have the same emergence angle of 45 degrees. However, these values are provided merely as examples and are not intended to be limiting; the emergence angles of the floating display modules may be modified according to the projection requirements. The first floating display module 701-2 and the third floating display module 703-2 respectively form a first angle β1b and a third angle β3b with a reference plane 790, and the continuous viewpoint region at least partially overlaps with the stereoscopic imaging space. A third coupling surface 702-2c of the second floating display module 702-2 is coincident with the reference plane 790. The continuous viewpoint region and the stereoscopic imaging space are combined (overlapped) to form a continuous viewpoint stereoscopic imaging space 787b. In the embodiment shown in FIG. 7B, the first angle β1b and the third angle β3b are both 30 degrees. However, these values are provided merely as examples and are not intended to be limiting; the respective angles between the floating display modules and the reference plane may be modified according to the projection requirements.

In the embodiment shown in FIG. 7C, the first floating display module 701-3, the second floating display module 702-3, and the third floating display module 703-3 have the same emergence angle of 45 degrees. However, these values are provided merely as examples and are not intended to be limiting; the emergence angles of the floating display modules may be modified according to the projection requirements. The first floating display module 701-3 and the third floating display module 703-3 respectively form a first angle β1c and a third angle β3c with a reference plane 790, and the continuous viewpoint region at least partially overlaps with the stereoscopic imaging space. A third coupling surface 702-3c of the second floating display module 702-3 is coincident with the reference plane 790. The continuous viewpoint region and the stereoscopic imaging space are combined (overlapped) to form a continuous viewpoint stereoscopic imaging space 787c. In the embodiment shown in FIG. 7C, the first angle β1c and the third angle β3c are both 27 degrees. However, these values are provided merely as examples and are not intended to be limiting; the respective angles between the floating display modules and the reference plane may be modified according to the projection requirements.

In the embodiment shown in FIG. 7D, the first floating display module 701-4, the second floating display module 702-4, and the third floating display module 703-4 have the same emergence angle of 45 degrees. However, these values are provided merely as examples and are not intended to be limiting; the emergence angles of the floating display modules may be modified according to the projection requirements. The first floating display module 701-4 and the third floating display module 703-4 respectively form a first angle β1d and a third angle β3d with a reference plane 790, and the continuous viewpoint region at least partially overlaps with the stereoscopic imaging space. A third coupling surface 702-4c of the second floating display module 702-4 is coincident with the reference plane 790. The continuous viewpoint region and the stereoscopic imaging space are combined (overlapped) to form a continuous viewpoint stereoscopic imaging space 787d. In the embodiment shown in FIG. 7D, the first angle β1d and the third angle β3d are both 25 degrees. However, these values are provided merely as examples and are not intended to be limiting; the respective angles between the floating display modules and the reference plane may be modified according to the projection requirements.

The continuous viewpoint stereoscopic imaging space in a floating stereoscopic display device is related to the size of the floating display module, the emergence angle, and the angle between the floating display module and the reference plane. With the same emergence angle, the smaller the angle between the floating display module and the reference plane, the larger the continuous viewpoint stereoscopic imaging space. For example, as shown in FIG. 7A, when the light field display (not shown) of each floating display module is 7.9 inches, a reflective projection element (not shown) with a long side length of 20 cm, an emergence angle of 45 degrees, and the first angle β1a and the third angle β3a both at 35 degrees, the volume of the continuous viewpoint stereoscopic imaging space 787a is 373,379 mm³. As shown in FIG. 7B, when the light field display (not shown) of each floating display module is 7.9 inches, a reflective projection element (not shown) with a long side length of 20 cm, an emergence angle of 45 degrees, and the first angle β1b and the third angle β3b both at 30 degrees, the volume of the continuous viewpoint stereoscopic imaging space 787b is 930,013 mm³. As shown in FIG. 7C, when the light field display (not shown) of each floating display module is 7.9 inches, a reflective projection element (not shown) with a long side length of 20 cm, an emergence angle of 45 degrees, and the first angle β1c and the third angle β3c both at 27 degrees, the volume of the continuous viewpoint stereoscopic imaging space 787c is 1,350,061 mm³. As shown in FIG. 7D, when the light field display (not shown) of each floating display module is 7.9 inches, a reflective projection element (not shown) with a long side length of 20 cm, an emergence angle of 45 degrees, and the first angle β1d and the third angle β3d both at 25 degrees, the volume of the continuous viewpoint stereoscopic imaging space 787d is 1,599,685 mm³. These values are provided as examples and are not intended to be limiting. Accordingly, as shown in FIGS. 7A to 7D, as the first and third angles decrease (from 35 degrees for β1a/β3a to 25 degrees for β1d/β3d), the volume of the continuous viewpoint stereoscopic imaging space increases (e.g., continuous viewpoint stereoscopic imaging spaces 787a to 787d). As shown in FIGS. 7A to 7D, since the light-emitting surface of the floating display module is trapezoidal with a longer upper edge and shorter lower edge, its longer upper edge provides a larger continuous viewpoint region. Consequently, the continuous viewpoint region and the continuous viewpoint stereoscopic imaging space are both a stereoscopic space that is larger at the top and smaller at the bottom.

As described above, the floating stereoscopic display device provided by the present invention can simultaneously adjust the size of the total viewing angle (which decreases as the angle between the floating display module and the reference plane decreases), the projection distance (which increases as the angle between the floating display module and the reference plane decreases), and the sizes of the continuous viewpoint region, the stereoscopic imaging space, and the continuous viewpoint stereoscopic imaging space (all of which increases as the angle between the floating display module and the reference plane decreases). This allows the projection effect to be modified according to requirements, overcoming the limitations of existing technologies.

Referring to FIGS. 8A to 8D, a floating display module 801-1 and three floating stereoscopic display devices 800b, 800c, and 800d are disclosed in one embodiment of the present invention. The floating stereoscopic display device 800b includes a first floating display module 801-2 and a second floating display module 802-2. The floating stereoscopic display device 800c includes a first floating display module 801-3, a second floating display module 802-3, and a third floating display module 803-3. The floating stereoscopic display device 800d includes a first floating display module 801-4, a second floating display module 802-4, a third floating display module 803-4, and a fourth floating display module 804-4. Like reference numerals indicate like components. For the sake of brevity, detailed descriptions are omitted herein, and the previously described floating stereoscopic display device and its related details are applicable to the present embodiment.

In the embodiment shown in FIG. 8A, a floating display module 801-1 is provided with a stereoscopic imaging space 850a. The previously described floating display module, light field display, reflective projection element, and related details are applicable to the present embodiment. Floating display module 801-1 has an emergence angle of 45 degrees. In this embodiment, since only one floating display module is present, the total viewing angle it provides is also 45 degrees. However, these values are provided as examples and are not intended to be limiting. When the light field display (not shown) of the floating display module 801-1 is 7.9 inches, a reflective projection element (not shown) with a long side length of 20 cm, an emergence angle of 45 degrees, the top side plane area of the stereoscopic imaging space 850a is 16,581 mm². These values are provided as examples and are not intended to be limiting.

In the embodiment shown in FIG. 8B, a floating stereoscopic display device 800b is provided. The floating stereoscopic display device 800b may be substantially similar to the floating stereoscopic display device 500 shown in FIGS. 5A to 5B, where like reference numerals indicate like components. For the sake of brevity, detailed descriptions are omitted herein, and the previously described floating display module, light field display, reflective projection element, and related details are applicable to the present embodiment. The first floating display module 801-2 and the second floating display module 802-2 have the same emergence angle of 45 degrees. The first floating display module 801-2 and the second floating display module 802-2 respectively form a first angle β1b and a second angle β2b with a reference plane 890, and a stereoscopic imaging space 850b is formed. The reference plane 890 may be perpendicular to a first coupling surface 802-2a or a second coupling surface 801-2b. In the embodiment shown in FIG. 8B, the first angle β1b and the second angle β2b are both 13.5 degrees, providing a total viewing angle of 72 degrees (β1b+β2b equals 27 degrees, and adding the average emergence angle of the outermost floating display modules 801-2, 802-2, which is 45 degrees). These values are provided as examples and are not intended to be limiting. When the light field display (not shown) of each floating display module is 7.9 inches, a reflective projection element (not shown) with a long side length of 20 cm, an emergence angle of 45 degrees, the top side plane area of the stereoscopic imaging space 850b is 13,509 mm². These values are provided as examples and are not intended to be limiting.

In the embodiment shown in FIG. 8C, a floating stereoscopic display device 800c is provided. The floating stereoscopic display device 800c may be substantially similar to the floating stereoscopic display device 600c shown in FIG. 6C, where like reference numerals indicate like components. For the sake of brevity, detailed descriptions are omitted herein, and the previously described floating display module, light field display, reflective projection element, and related details are applicable to the present embodiment. The first floating display module 801-3, the second floating display module 802-3, and the third floating display module 803-3 have the same emergence angle of 45 degrees. The first floating display module 801-3 and the third floating display module 803-3 respectively form a first angle β1c and a third angle β3c with a reference plane 890, where a third coupling surface 802-3c of the second floating display module 802-3 is coincident with the reference plane 890, and a stereoscopic imaging space 850c is formed. In the embodiment shown in FIG. 8C, the first angle β1c and the third angle β3c are both 27 degrees, providing a total viewing angle of 99 degrees (β1c+β3c equals 54 degrees, and adding the average emergence angle of the outermost floating display modules 801-3, 803-3, which is 45 degrees). These values are provided as examples and are not intended to be limiting. When the light field display (not shown) of each floating display module is 7.9 inches, a reflective projection element (not shown) with a long side length of 20 cm, an emergence angle of 45 degrees, the top side plane area of the stereoscopic imaging space 850c is 12,234 mm². These values are provided as examples and are not intended to be limiting.

In the embodiment shown in FIG. 8D, a floating stereoscopic display device 800d is provided. The previously described floating display module, light field display, reflective projection element, and related details are applicable to the present embodiment. The first floating display module 801-4, the second floating display module 802-4, the third floating display module 803-4, and the fourth floating display module 804-4 have the same emergence angle of 45 degrees. The first floating display module 801-4, the second floating display module 802-4, the third floating display module 803-4, and the fourth floating display module 804-4 respectively form a first angle β1d, a second angle β2d, a third angle β3d, and a fourth angle β4d with a reference plane 890, and a stereoscopic imaging space 850d is formed. The reference plane 890 may be perpendicular to a first coupling surface 803-4a or a second coupling surface 802-4b. In the embodiment shown in FIG. 8D, the first angle β1d and the fourth angle β4d are both 40.5 degrees, providing a total viewing angle of 126 degrees (β1d+β4d equals 81 degrees, and adding the average emergence angle of the outermost floating display modules 801-4, 804-4, which is 45 degrees). These values are provided as examples and are not intended to be limiting. When the light field display (not shown) of each floating display module is 7.9 inches, a reflective projection element (not shown) with a long side length of 20 cm, an emergence angle of 45 degrees, the top side plane area of the stereoscopic imaging space 850d is 11,574 mm². These values are provided as examples and are not intended to be limiting.

The total viewing angle and size of the stereoscopic imaging space of a floating stereoscopic display device are related to the number of floating display modules. With the same emergence angle, a larger number of floating display modules results in a larger total viewing angle. As shown in FIGS. 8A to 8D, the total viewing angle increases from 45 degrees to 126 degrees as the number of floating display modules increases. With the same emergence angle, a larger number of floating display modules results in a smaller stereoscopic imaging space. As shown in FIGS. 8A to 8D, the size of the stereoscopic imaging space (e.g., stereoscopic imaging spaces 850a to 850d) decreases as the number of floating display modules increases.

In summary, the floating stereoscopic display device provided by the present invention can also adjust the size of the total viewing angle (which increases as the number of floating display modules increases), the continuous viewpoint region, the stereoscopic imaging space, and the continuous viewpoint stereoscopic imaging space (all of which decreases as the number of floating display modules increases) by adjusting the number of floating display modules. Therefore, the projection effect can be modified according to requirements, overcoming the limitations of existing technologies.

Referring to FIGS. 9A to 9C, a floating stereoscopic display device 900 is disclosed in one embodiment of the present invention. The floating stereoscopic display device 900 includes a first floating display module 901, a second floating display module 902, and a third floating display module 903, which collectively project stereoscopic images to form a floating stereoscopic image 960. The floating stereoscopic display device 900 may be substantially similar to the floating stereoscopic display device 100 shown in FIG. 1J, where like reference numerals indicate like components. For the sake of brevity, detailed descriptions are omitted herein, and the previously described floating stereoscopic display device and its related details are applicable to the present embodiment.

As shown in FIGS. 9A to 9C, the floating stereoscopic display device 900 can provide floating stereoscopic image 960 from different viewing angles. For example, as shown in FIG. 9A, the floating stereoscopic display device 900 can provide a floating stereoscopic image 960 similar to that shown in FIG. 1C within a first horizontal angle range 141. As shown in FIG. 9B, the floating stereoscopic display device 900 can provide a floating stereoscopic image 960 similar to that shown in FIG. 1F within a second horizontal angle range 142. As shown in FIG. 9C, the floating stereoscopic display device 900 can provide a floating stereoscopic image 960 similar to that shown in FIG. 1I within a third horizontal angle range 143. The floating stereoscopic display device provided by the present invention utilizes multiple floating display modules arranged in a spliced configuration. Different floating display modules provide distinct viewing angle information, enabling the generation of wide-angle floating stereoscopic images. Consequently, the projection effect can be modified as needed to overcome limitations of existing technologies, thereby expanding the application scope of the technology.

The previous description of the invention is provided to enable a person of ordinary skill in the art to make or practice the invention. Various modifications to the invention will be apparent to those people of ordinary skill in the art, and the general principles defined herein may be applied to other variations or the embodiments may be combined with each other or implemented separately without departing from the spirit or scope of the invention. Thus, the present invention is not intended to be limited to the examples described herein but is to be accorded the widest scope consistent with the principles and novel features of the invention herein.

What is claimed is:

1. A floating stereoscopic display device, comprising:
a plurality of floating display modules disposed adjacent to each other, wherein each of the plurality of floating display modules comprises an image processor, and wherein
the image processor of each of the plurality of floating display modules provides respective stereoscopic image data, wherein the stereoscopic image data provided by each of the image processors is generated in response to different simulated viewing angle ranges of reference image data;
each of the plurality of floating display modules projects a stereoscopic image in a corresponding one of a plurality of stereoscopic display spaces according to the respective stereoscopic image data; and
wherein the plurality of stereoscopic display spaces are at least partially overlapped to form a stereoscopic imaging space, and the stereoscopic images projected by the plurality of floating display modules in the stereoscopic imaging space are combined to form a floating stereoscopic image.

2. The device of claim 1, wherein each of the plurality of floating display modules comprises a focal plane, and the focal planes of the plurality of floating display modules are intersected in an axis, and the axis is a rotational symmetry axis of the stereoscopic imaging space.

3. The device of claim 2, wherein the axis has a reference coordinate point, and each of the stereoscopic images is projected in the stereoscopic imaging space according to the reference coordinate point.

4. The device of claim 1, wherein each of the plurality of floating display modules comprises a light field display and a reflective projection element, and for each of the plurality of floating display modules, the stereoscopic image is projected from the light field display to the corresponding one of the plurality of stereoscopic display spaces through the reflective projection element; wherein the reflective projection elements of the plurality of floating display modules are disposed adjacent to each other.

5. The device of claim 4, wherein for each of the plurality of floating display modules, a portion of the floating display module adjacent to the reflective projection element comprises a light-absorbing material or an opaque material.

6. The device of claim 1, wherein each of the plurality of floating display modules comprises a first coupling surface and a second coupling surface, and the plurality of floating display modules are adjacently spliced to each other through the first coupling surfaces and the second coupling surfaces of the plurality of floating display modules.

7. The device of claim 6, wherein for each of the plurality of floating display modules, the first coupling surface and the second coupling surface comprise a light-absorbing material or an opaque material.

8. The device of claim 6, wherein the first coupling surface and the second coupling surface correspondingly spliced to each other are completely overlapped.

9. The device of claim 6, wherein for each of the plurality of floating display modules, an included angle is formed between the first coupling surface and the second coupling surface; the plurality of floating display modules are arranged adjacent to each other around the stereoscopic imaging space based on the included angle of each of the plurality of floating display modules.

10. The device of claim 9, wherein each of the plurality of floating display modules has an emergence angle to provide a viewpoint region, and the viewpoint regions of the plurality of floating display modules are at least partially overlapped to form a continuous viewpoint region.

11. The device of claim 10, wherein for each of the plurality of floating display modules, the included angle is smaller than the emergence angle.

12. The device of claim 10, wherein the plurality of floating display modules comprise a first floating display module and a second floating display module respectively forming an angle with a reference plane, and the continuous viewpoint region at least partially overlaps with the stereoscopic imaging space.

13. The device of claim 12, wherein for each of the plurality of floating display modules, the angle is smaller than the emergence angle.

14. The device of claim 13, wherein the angle is between 12.5 degrees and 17.5 degrees, and the emergence angle is between 40 degrees and 45 degrees.

15. The device of claim 10, wherein the plurality of floating display modules comprise a first floating display module, a second floating display module, and a third floating display module, wherein the first floating display module and the third floating display module respectively form an angle with a reference plane, and the continuous viewpoint region at least partially overlaps with the stereoscopic imaging space, and a surface of the second floating display module is coincident with the reference plane.

16. The device of claim 15, wherein for each of the plurality of floating display modules, the angle is smaller than the emergence angle.

17. The device of claim 16, wherein the angle is between 25 degrees and 35 degrees, and the emergence angle is between 40 degrees and 45 degrees.

18. The device of claim 1, wherein the different simulated viewing angle ranges of the reference image data comprise a plurality of horizontal angle ranges, and each of the stereoscopic image data provided by each of the image processors is generated in response to each of the plurality of horizontal angle ranges.

19. The device of claim 18, wherein the plurality of floating display modules comprise a first floating display module, a second floating display module, and a third floating display module, and the plurality of horizontal angle ranges comprise a first horizontal angle range, a second horizontal angle range, and a third horizontal angle range.

20. The device of claim 19, wherein the first horizontal angle range is from -50 degrees to -5 degrees, the second horizontal angle range is from -22.5 degrees to 22.5 degrees, and the third horizontal angle range is from 5 degrees to 50 degrees.
